(19) United States
(12) Patent Application Publication
(10) Pub. No.: US 2025/0310659 A1
(43) Pub. Date: Oct. 2, 2025

(54) HIGH DYNAMIC RANGE (HDR) IMAGE CAPTURING APPARATUS, SYSTEM, AND METHOD

(71) Applicant: Mobileye Vision Technologies Ltd., Jerusalem (IL)

(72) Inventors: Gabriel Bowers, Boulogne-Billancourt (FR); Amit Weizner, Haifa (IL)

(73) Assignee: Mobileye Vision Technologies Ltd., Jerusalem (IL)

(21) Appl. No.: 19/083,733

(22) Filed: Mar. 19, 2025

Related U.S. Application Data
(60) Provisional application No. 63/570,165, filed on Mar. 26, 2024.
(60) Provisional application No. 63/643,535, filed on May 7, 2024.
(60) Provisional application No. 63/677,002, filed on Jul. 30, 2024.

(51) Int. Cl. H04N 25/585; H04N 25/42; H04N 25/78

(52) U.S. Cl. CPC H04N 25/585; H04N 25/42; H04N 25/78

(57) ABSTRACT

Techniques are disclosed for improving the manner in which multiple HDR images are generated having different exposure times. The technicism allow for the use of a single imaging sensor to generate HDR images with a reduced latency required to do so. The result is that both long and high exposure HDR images may be generated in a much faster time frame than that required for traditional HDR sensors, which may be a time offset of the shorter exposure time of the two HDR images. This allows for the images to capture more similar scenes given the proximity in time in which both are generated, allowing for more accurate vehicle-based functions to be implemented that rely upon such HDR images, such as object classification.

### CROSS-REFERENCE TO RELATED APPLICATIONS

This application claims priority to provisional application No. 63,570,165, filed on Mar. 26, 2024, to provisional application No. 63,677,002, filed on Jul. 30, 2024, and to provisional application No. 63,643,535, filed on May 7, 2024, the contents of each of which are incorporated herein by reference in their entireties.

### TECHNICAL FIELD

Aspects described herein generally relate to the use of high dynamic range (HDR) imaging and, in particular, to HDR imaging systems that generate HDR images with different exposure times per HDR image frame, which may be used to perform various vehicle-based functions.

### BACKGROUND

Autonomous vehicle (AV) and advanced driver-assistance systems (ADAS) use cameras to perform various vehicle-based functions, which may include feature and/or object detection with respect to a road scene. Complementary metal oxide semiconductor (CMOS) image sensors (CIS) may include pixels, analog and digital circuits, and a transmitter, which may be implemented for a wide range of applications including the aforementioned AV and ADAS based applications. However, the use of such conventional cameras for AVs and ADAS have drawbacks, as certain exposure times are better suited to detecting features and objects in specific environments. Moreover, the sequential generation of multiple HDR images with different exposure times introduces significant system latency and results in different scenes being captured in each of the different exposure images. This added latency may also manifest itself with respect to the execution of vehicle-based functions that rely upon the HDR image data.

### BRIEF DESCRIPTION OF THE DRAWINGS/FIGURES

The accompanying drawings, which are incorporated herein and form a part of the specification, illustrate the aspects of the present disclosure and, together with the description, and further serve to explain the principles of the aspects and to enable a person skilled in the pertinent art to make and use the aspects.

FIG. 1 illustrates an example vehicle in accordance with one or more aspects of the present disclosure.

FIG. 2 illustrates various example electronic components of a safety system of a vehicle in accordance with one or more aspects of the present disclosure;

FIG. 3A illustrates a conventional multi-frame HDR image generation technique;

FIG. 3B illustrates a conventional HDR imager;

FIGS. 4A-4B and 5 illustrate a conventional HDR image generation process;

FIG. 6 illustrates a conventional output of two HDR images having different exposure times;

FIGS. 7A-7C and 8 illustrates an HDR image generation process for generating two HDR images with different exposure values, in accordance with one or more aspects of the present disclosure;

FIGS. 9A and 9B illustrate a comparison between a conventional output of two HDR images having different exposure times and the output of two HDR images having different exposure times, in accordance with one or more aspects of the present disclosure;

FIG. 10 illustrates an HDR imager, in accordance with one or more aspects of the present disclosure;

FIGS. 11A-11C illustrate different color channel binning processes used for HDR image resizing, in accordance with one or more aspects of the present disclosure;

FIGS. 12A-12D illustrate examples of different weighting combinations used for non-dominate channel binning, in accordance with one or more aspects of the present disclosure;

FIGS. 13A-13B illustrate a comparison between a mono color binning process used for dominate channel binning and a bayer color binning process, in accordance with one or more aspects of the present disclosure;

FIGS. 14A-14B illustrate a pixel encoding examples for image resizing implementing different binning processes for dominant and non-dominate color channels, in accordance with one or more aspects of the present disclosure;

FIG. 15A-15B illustrate example charts for HDR noise plots when PWL Companding is reduced from 10 bits per pixel to 12 bits per pixel, in accordance with one or more aspects of the present disclosure;

FIGS. 16A-16B illustrate a comparison of long and short exposure HDR, in accordance with one or more aspects of the present disclosure;

FIGS. 17A-17B illustrate a comparison of HDR images generated by further increasing the long exposure integration time, in accordance with one or more aspects of the present disclosure;

FIG. 18 illustrates an example process flow, in accordance with one or more aspects of the present disclosure;

FIG. 19 illustrates an example computing device, in accordance with one or more aspects of the present disclosure; and

FIG. 20 illustrates an example of noise model based compression for residual image compression, in accordance with one or more aspects of the present disclosure.

The exemplary aspects of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

### I. Autonomous Vehicle Architecture and Operation

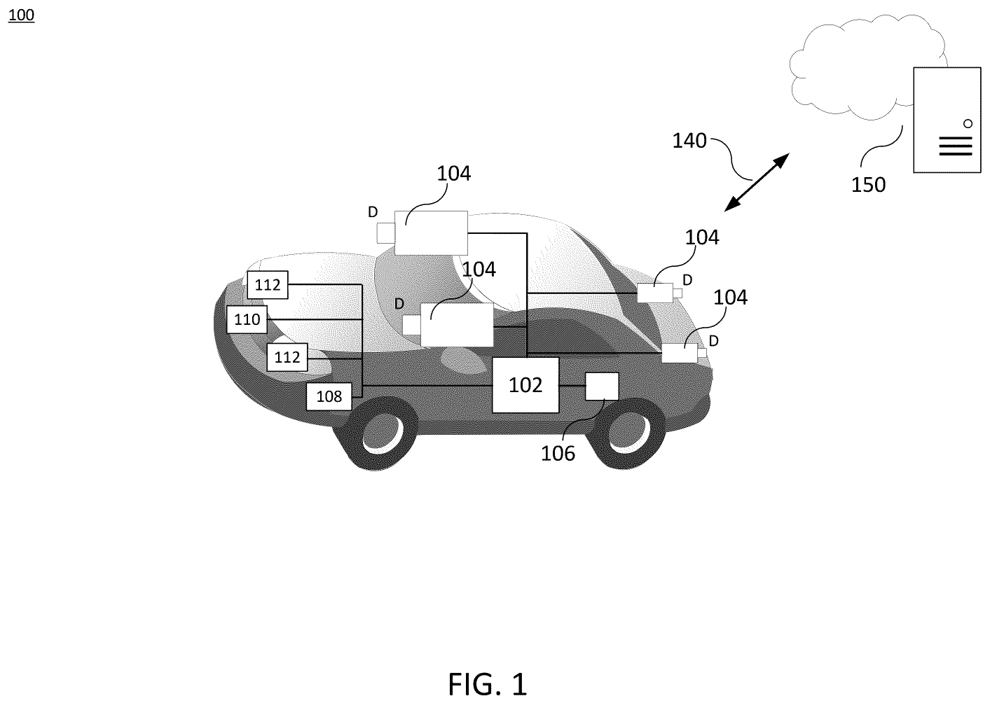

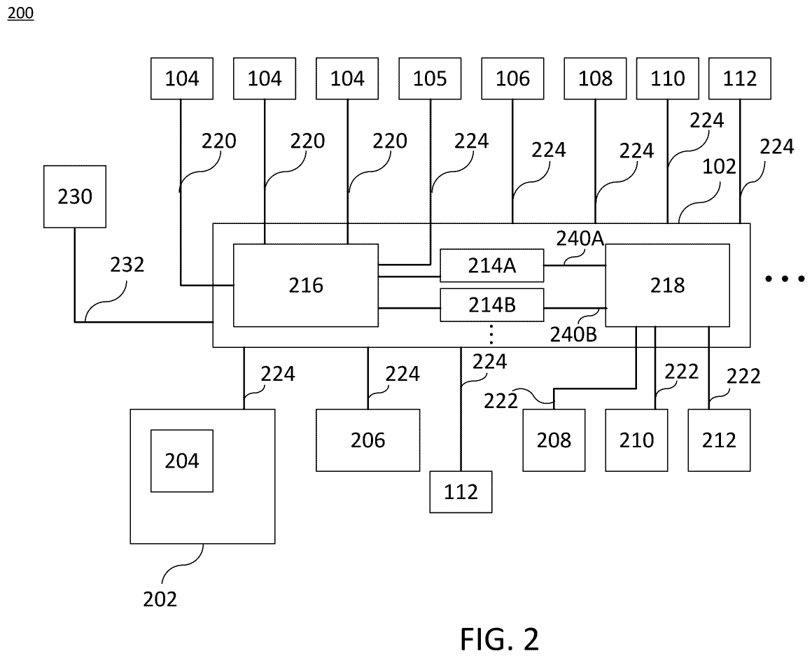

FIG. 1 shows a vehicle 100 including a safety system 200 (see also FIG. 2) in accordance with various aspects of the present disclosure. The vehicle 100 and the safety system 200 are exemplary in nature, and may thus be simplified for explanatory purposes. Locations of elements and relational distances (as discussed herein, the Figures are not to scale) and are provided by way of example and not limitation. The safety system 200 may include various components depending on the requirements of a particular implementation and/or application, and may facilitate the navigation and/or control of the vehicle 100. The vehicle 100 may be an autonomous vehicle (AV), which may include any level of automation (e.g. levels 0-5), which includes no automation or full automation (level 5). The vehicle 100 may implement the safety system 200 as part of any suitable type of autonomous or driving assistance control system, including AV and/or advanced driver-assistance system (ADAS), for instance. The safety system 200 may include one or more components that are integrated as part of the vehicle 100 during manufacture, part of an add-on or aftermarket device, or combinations of these. Thus, the various components of the safety system 200 as shown in FIG. 2 may be integrated as part of the vehicle's systems and/or part of an aftermarket system that is installed in the vehicle 100.

The one or more processors 102 may be integrated with or separate from an electronic control unit (ECU) of the vehicle 100 or an engine control unit of the vehicle 100, which may be considered herein as a specialized type of an electronic control unit. The safety system 200 may generate data to control or assist to control the ECU and/or other components of the vehicle 100 to directly or indirectly control the driving of the vehicle 100. However, the aspects described herein are not limited to implementation within autonomous or semi-autonomous vehicles, as these are provided by way of example. The aspects described herein may be implemented as part of any suitable type of vehicle that may be capable of travelling with or without any suitable level of human assistance in a particular driving environment. Therefore, one or more of the various vehicle components such as those discussed herein with reference to FIG. 2 for instance, may be implemented as part of a standard vehicle (i.e. a vehicle not using autonomous driving functions), a fully autonomous vehicle, and/or a semi-autonomous vehicle, in various aspects. In aspects implemented as part of a standard vehicle, it is understood that the safety system 200 may perform alternate functions, and thus in accordance with such aspects the safety system 200 may alternatively represent any suitable type of system that may be implemented by a standard vehicle without necessarily utilizing autonomous or semi-autonomous control related functions.

Regardless of the particular implementation of the vehicle 100 and the accompanying safety system 200 as shown in FIG. 1 and FIG. 2, the safety system 200 may include one or more processors 102, one or more image acquisition devices 104 such as, e.g., one or more cameras or any other suitable sensor configured to perform image acquisition over any suitable range of wavelengths, one or more position sensors 106, which may be implemented as a position and/or location-identifying system such as a Global Navigation Satellite System (GNSS), e.g., a Global Positioning System (GPS), one or more memories 202, one or more map databases 204, one or more user interfaces 206 (such as, e.g., a display, a touch screen, a microphone, a loudspeaker, one or more buttons and/or switches, and the like), and one or more wireless transceivers 208, 210, 212.

The wireless transceivers 208, 210, 212 may be configured to operate in accordance with any suitable number and/or type of desired radio communication protocols or standards. By way of example, a wireless transceiver (e.g., a first wireless transceiver 208) may be configured in accordance with a Short Range mobile radio communication standard such as e.g. Bluetooth, Zigbee, and the like. As another example, a wireless transceiver (e.g., a second wireless transceiver 210) may be configured in accordance with a Medium or Wide Range mobile radio communication standard such as e.g. a 3G (e.g. Universal Mobile Telecommunications System—UMTS), a 4G (e.g. Long Term Evolution—LTE), or a 5G mobile radio communication standard in accordance with corresponding 3GPP (3rd Generation Partnership Project) standards, the most recent version at the time of this writing being the 3GPP Release 16 (2020).

As a further example, a wireless transceiver (e.g., a third wireless transceiver 212) may be configured in accordance with a Wireless Local Area Network communication protocol or standard such as e.g. in accordance with IEEE 802.11 Working Group Standards, the most recent version at the time of this writing being IEEE Std 802.11™-2020, published Feb. 26, 2021 (e.g. 802.11, 802.11a, 802.11b, 802.11g, 802.11n, 802.11p, 802.11-12, 802.11ac, 802.11ad, 802.11ah, 802.11ax, 802.11ay, and the like). The one or more wireless transceivers 208, 210, 212 may be configured to transmit signals via an antenna system (not shown) using an air interface. As additional examples, one or more of the transceivers 208, 210, 212 may be configured to implement one or more vehicle to everything (V2X) communication protocols, which may include vehicle to vehicle (V2V), vehicle to infrastructure (V2I), vehicle to network (V2N), vehicle to pedestrian (V2P), vehicle to device (V2D), vehicle to grid (V2G), and any other suitable communication protocols.

One or more of the wireless transceivers 208, 210, 212 may additionally or alternatively be configured to enable communications between the vehicle 100 and one or more other remote computing devices 150 via one or more wireless links 140. This may include, for instance, communications with a remote server or other suitable computing system 150 as shown in FIG. 1. The example shown FIG. 1 illustrates such a remote computing system 150 as a cloud computing system, although this is by way of example and not limitation, and the computing system 150 may be implemented in accordance with any suitable architecture and/or network and may constitute one or several physical computers, servers, processors, etc. that comprise such a system. As another example, the computing system 150 may be implemented as an edge computing system and/or network.

The one or more processors 102 may implement any suitable type of processing circuitry, other suitable circuitry, memory, etc., and utilize any suitable type of architecture. The one or more processors 102 may be configured as a controller implemented by the vehicle 100 to perform various vehicle-based functions, which may include for instance vehicle control functions, navigational functions, etc. For example, the one or more processors 102 may be configured to function as a controller for the vehicle 100 to analyze sensor data and received communications, to calculate specific vehicle-based actions for the vehicle 100 to execute for navigation and/or control of the vehicle 100, and to cause the corresponding action to be executed, which may be in accordance with an AV or ADAS system, for instance. The one or more processors 102 and/or any suitable components of the safety system 200 (including the entirety of the safety system 200) may form the entirety of or portion of an advanced driver-assistance system (ADAS) or an autonomous vehicle (AV) system as discussed herein.

Moreover, one or more of the processors 214A, 214B, 216, and/or 218 of the one or more processors 102 may be configured to work in cooperation with one another and/or with other components of the vehicle 100 to collect information about the environment (e.g., sensor data, such as images, depth information (for a Lidar for example), etc.). In this context, one or more of the processors 214A, 214B, 216, and/or 218 of the one or more processors 102 may be referred to as “processors.” The processors may thus be implemented (independently or together) to create mapping information from the harvested data, e.g., Road Segment Data (RSD) information that may be used for Road Experience Management (REM) mapping technology, the details of which are further described below. As another example, the processors can be implemented to process mapping information (e.g. roadbook information used for REM mapping technology) received from remote servers over a wireless communication link (e.g. link 140) to localize the vehicle 100 on an AV map, which can be used by the processors to control the vehicle 100.

The one or more processors 102 may include one or more application processors 214A, 214B, an image processor 216, a communication processor 218, and may additionally or alternatively include any other suitable processing device, circuitry, components, etc. not shown in the Figures for purposes of brevity. Similarly, image acquisition devices 104 may include any suitable number of image acquisition devices and components depending on the requirements of a particular application. Image acquisition devices 104 may include one or more image capture devices (e.g., cameras, charge coupling devices (CCDs), high dynamic range (HDR) imagers, or any other suitable type of image sensor). The safety system 200 may also include a data interface communicatively connecting the one or more processors 102 to the one or more image acquisition devices 104. For example, a first data interface may include any wired and/or wireless first link 220, or first links 220 for transmitting image data acquired by the one or more image acquisition devices 104 to the one or more processors 102, e.g., to the image processor 216.

The wireless transceivers 208, 210, 212 may be coupled to the one or more processors 102, e.g., to the communication processor 218, e.g., via a second data interface. The second data interface may include any wired and/or wireless second link 222 or second links 222 for transmitting radio transmitted data acquired by wireless transceivers 208, 210, 212 to the one or more processors 102, e.g., to the communication processor 218. Such transmissions may also include communications (one-way or two-way) between the vehicle 100 and one or more other (target) vehicles in an environment of the vehicle 100 (e.g., to facilitate coordination of navigation of the vehicle 100 in view of or together with other (target) vehicles in the environment of the vehicle 100), or even a broadcast transmission to unspecified recipients in a vicinity of the transmitting vehicle 100.

The memories 202, as well as the one or more user interfaces 206, may be coupled to each of the one or more processors 102, e.g., via a third data interface. The third data interface may include any wired and/or wireless third link 224 or third links 224. Furthermore, the position sensors 106 may be coupled to each of the one or more processors 102, e.g., via the third data interface.

Each processor 214A, 214B, 216, 218 of the one or more processors 102 may be implemented as any suitable number and/or type of hardware-based processing devices (e.g. processing circuitry), and may collectively, i.e. with the one or more processors 102, form one or more types of controllers as discussed herein. The architecture shown in FIG. 2 is provided for ease of explanation and as an example, and the vehicle 100 may include any suitable number of the one or more processors 102, each of which may be similarly configured to utilize data received via the various interfaces and to perform one or more specific tasks.

For example, the one or more processors 102 may form a controller that is configured to perform various vehicle-based functions, which may include control-related functions of the vehicle 100 such as the calculation and execution of a specific vehicle following speed, velocity, acceleration, braking, steering, trajectory, etc. As another example, the vehicle 100 may, in addition to or as an alternative to the one or more processors 102, implement other processors (not shown) that may form a different type of controller that is configured to perform additional or alternative types of control-related functions. Each controller may be responsible for controlling specific subsystems and/or controls associated with the vehicle 100. In accordance with such aspects, each controller may receive data from respectively coupled components as shown in FIG. 2 via respective interfaces (e.g. 220, 222, 224, 232, etc.), with the wireless transceivers 208, 210, and/or 212 providing data to the respective controller via the second links 222, which function as communication interfaces between the respective wireless transceivers 208, 210, and/or 212 and each respective controller in this example.

To provide another example, the application processors 214A, 214B may individually represent respective controllers that work in conjunction with the one or more processors 102 to perform specific control-related tasks. For instance, the application processor 214A may be implemented as a first controller, whereas the application processor 214B may be implemented as a second and different type of controller that is configured to perform other types of tasks as discussed further herein. In accordance with such aspects, the one or more processors 102 may receive data from respectively coupled components as shown in FIG. 2 via the various interfaces 220, 222, 224, 232, etc., and the communication processor 218 may provide communication data received from other vehicles (or to be transmitted to other vehicles) to each controller via the respectively coupled links 240A, 240B, which function as communication interfaces between the respective application processors 214A, 214B and the communication processors 218 in this example.

The one or more processors 102 may additionally be implemented to communicate with any other suitable components of the vehicle 100 to determine a state of the vehicle while driving or at any other suitable time. For instance, the vehicle 100 may include one or more vehicle computers, sensors, ECUs, interfaces, etc., which may collectively be referred to as vehicle components 230 as shown in FIG. 2. The one or more processors 102 are configured to communicate with the vehicle components 230 via an additional data interface 232, which may represent any suitable type of links and operate in accordance with any suitable communication protocol (e.g. CAN bus communications). Using the data received via the data interface 232, the one or more processors 102 may determine any suitable type of vehicle status information such as the current drive gear, current engine speed, acceleration capabilities of the vehicle 100, etc. As another example, various metrics used to control the speed, acceleration, braking, steering, etc. may be received via the vehicle components 230, which may include receiving any suitable type of signals that are indicative of such metrics or varying degrees of how such metrics vary over time (e.g. brake force, wheel angle, reverse gear, etc.).

The one or more processors 102 may include any suitable number of other processors 214A, 214B, 216, 218, each of which may comprise processing circuitry such as sub-processors, a microprocessor, pre-processors (such as an image pre-processor), graphics processors, a central processing unit (CPU), support circuits, digital signal processors, integrated circuits, memory, or any other types of devices suitable for running applications and for data processing (e.g. image processing, audio processing, etc.) and analysis and/or to enable vehicle-based functions and/or vehicle control to be functionally realized. In some aspects, each processor 214A, 214B, 216, 218 may include any suitable type of single or multi-core processor, microcontroller, central processing unit, etc. These processor types may each include multiple processing units with local memory and instruction sets. Such processors may include video inputs for receiving image data from multiple image sensors, and may also include video out capabilities.

Any of the processors 214A, 214B, 216, 218 disclosed herein may be configured to perform certain functions in accordance with program instructions, which may be stored in the local memory of each respective processor 214A, 214B, 216, 218, or accessed via another memory that is part of the safety system 200 or external to the safety system 200. This memory may include the one or more memories 202. Regardless of the particular type and location of memory, the memory may store software and/or executable (i.e. computer-readable) instructions that, when executed by a relevant processor (e.g., by the one or more processors 102, one or more of the processors 214A, 214B, 216, 218, etc.), controls the operation of the safety system 200 and may perform other functions such those identified with the aspects described in further detail below. This may include, for instance, generating multiple images per frame having different exposures, using any of these generated images to perform any suitable vehicle-based functions, etc., as further discussed herein.

A relevant memory accessed by the one or more processors 214A, 214B, 216, 218 (e.g. the one or more memories 202) may also store one or more databases and image processing software, as well as a trained system, such as a neural network, or a deep neural network, for example, that may be utilized to perform the tasks in accordance with any of the aspects as discussed herein. A relevant memory accessed by the one or more processors 214A, 214B, 216, 218 (e.g. the one or more memories 202) may be implemented as any suitable number and/or type of non-transitory computer-readable medium such as random access memories, read only memories, flash memories, disk drives, optical storage, tape storage, removable storage, or any other suitable types of storage.

The components associated with the safety system 200 as shown in FIG. 2 are illustrated for case of explanation and by way of example and not limitation. The safety system 200 may include additional, fewer, or alternate components as shown and discussed herein with reference to FIG. 2. Moreover, one or more components of the safety system 200 may be integrated or otherwise combined into common processing circuitry components or separated from those shown in FIG. 2 to form distinct and separate components. For instance, one or more of the components of the safety system 200 may be integrated with one another on a common die or chip. As an illustrative example, the one or more processors 102 and the relevant memory accessed by the one or more processors 214A, 214B, 216, 218 (e.g. the one or more memories 202) may be integrated on a common chip, die, package, etc., and together comprise a controller or system configured to perform one or more specific tasks or functions. Again, such a controller or system may be configured to execute the various functions related to implementing the images generated herein having different exposure values for performing various vehicle-based functions, to control various parameters of the image acquisition devices 104, and/or to control the state of the vehicle 100, as discussed in further detail herein.

In some aspects, the safety system 200 may further include components such as a speed sensor 108 (e.g. a speedometer) for measuring a speed of the vehicle 100. The safety system 200 may also include one or more sensors 105, which may include one or more accelerometers (either single axis or multiaxis) for measuring accelerations of the vehicle 100 along one or more axes, and additionally or alternatively one or more gyro sensors. The one or more sensors 105 may further include additional sensors or different sensor types such as an ultrasonic sensor, infrared sensors, a thermal sensor, digital compasses, and the like. The safety system 200 may also include one or more radar sensors 110 and one or more LIDAR sensors 112 (which may be integrated in the head lamps of the vehicle 100). The radar sensors 110 and/or the LIDAR sensors 112 may be configured to provide pre-processed sensor data, such as radar target lists or LIDAR target lists. The third data interface (e.g., one or more links 224) may couple the one or more sensors 105, the speed sensor 108, the one or more radar sensors 110, and the one or more LIDAR sensors 112 to at least one of the one or more processors 102.

### II. Autonomous Vehicle (AV) Map Data and Road Experience Management (REM)

Data referred to as REM map data (or alternatively as Roadbook Map data or AV map data), may also be stored in a relevant memory accessed by the one or more processors 214A, 214B, 216, 218 (e.g. the one or more memories 202) or in any suitable location and/or format, such as in a local or cloud-based database, accessed via communications between the vehicle and one or more external components (e.g. via the transceivers 208, 210, 212), etc. It is noted that although referred to herein as “AV map data,” the data may be implemented in any suitable vehicle platform, which may include vehicles having any suitable level of automation (e.g. levels 0-5), as noted above.

Regardless of where the AV map data is stored and/or accessed, the AV map data may include a geographic location of known landmarks that are readily identifiable in the navigated environment in which the vehicle 100 travels. The location of the landmarks may be generated from a historical accumulation from other vehicles driving on the same road that collect data regarding the appearance and/or location of landmarks (e.g. “crowd sourcing”). Thus, each landmark may be correlated to a set of predetermined geographic coordinates that has already been established. Therefore, in addition to the use of location-based sensors such as GNSS, the database of landmarks provided by the AV map data enables the vehicle 100 to identify the landmarks using the one or more image acquisition devices 104. Once identified, the vehicle 100 may implement other sensors such as LIDAR, accelerometers, speedometers, etc. or images from the image acquisitions device 104, to evaluate the position and location of the vehicle 100 with respect to the identified landmark positions.

Furthermore, the vehicle 100 may determine its own motion, which is referred to as “ego-motion.” Ego-motion is generally used for computer vision algorithms and other similar algorithms to represent the motion of a vehicle camera across a plurality of frames, which provides a baseline (i.e. a spatial relationship) that can be used to compute the 3D structure of a scene from respective images. The vehicle 100 may analyze its own ego-motion to track the position and orientation of the vehicle 100 with respect to the identified known landmarks. Because the landmarks are identified with predetermined geographic coordinates, the vehicle 100 may determine its geographic location and position on a map based upon a determination of its position with respect to identified landmarks using the landmark-correlated geographic coordinates. Doing so provides distinct advantages that combine the benefits of smaller scale position tracking with the reliability of GNSS positioning systems while avoiding the disadvantages of both systems. It is further noted that the analysis of ego motion in this manner is one example of an algorithm that may be implemented with monocular imaging to determine a relationship between a vehicle's location and the known location of known landmark(s), thus assisting the vehicle to localize itself. However, ego-motion is not necessary or relevant for other types of technologies, and therefore is not essential for localizing using monocular imaging. Thus, in accordance with the aspects as described herein, the vehicle 100 may leverage any suitable type of localization technology.

Thus, the AV map data is generally constructed as part of a series of steps, which may involve any suitable number of vehicles that opt into the data collection process. As each vehicle collects data, the data is classified into tagged data points, which are then transmitted to the cloud or to another suitable external location. A suitable computing device (e.g. a cloud server) then analyzes the data points from individual drives on the same road, and aggregates and aligns these data points with one another. After alignment has been performed, the data points are used to define a precise outline of the road infrastructure. Next, relevant semantics are identified that enable vehicles to understand the immediate driving environment, i.e. features and objects are defined that are linked to the classified data points. The features and/or objects defined in this manner may include, for instance, traffic lights, road arrows, signs, road edges, drivable paths, lane split points, stop lines, lane markings, etc. to the driving environment so that a vehicle may readily identify these features and objects using the AV map data. This information is then compiled into a Roadbook Map, which constitutes a bank of driving paths, semantic road information such as features and objects, and aggregated driving behavior.

A map database 204, which may be stored as part of the one or more memories 202 or accessed via the computing system 150 via the link(s) 140, for instance, may include any suitable type of database configured to store (digital) map data for the vehicle 100, e.g., for the safety system 200. The one or more processors 102 may download information to the map database 204 over a wired or wireless data connection (e.g. the link(s) 140) using a suitable communication network (e.g., over a cellular network and/or the Internet, etc.). Again, the map database 204 may store the AV map data, which includes data relating to the position, in a reference coordinate system, of various landmarks such as items, including roads, water features, geographic features, businesses, points of interest, restaurants, gas stations, etc.

The map database 204 may thus store, as part of the AV map data, not only the locations of such landmarks, but also descriptors relating to those landmarks, including, for example, names associated with any of the stored features, and may also store information relating to details of the items such as a precise position and orientation of items. In some cases, the Roadbook Map data may store a sparse data model including polynomial representations of certain road features (e.g., lane markings) or target trajectories for the vehicle 100. The AV map data may also include stored representations of various recognized landmarks that may be provided to determine or update a known position of the vehicle 100 with respect to a target trajectory. The landmark representations may include data fields such as landmark type, landmark location, etc., among other potential identifiers. The AV map data may also include non-semantic features including point clouds of certain objects or features in the environment, and feature point and descriptors.

The map database 204 may be augmented with data in addition to the AV map data, and/or the map database 204 and/or the AV map data may reside partially or entirely as part of the remote computing system 150. As discussed herein, the location of known landmarks and map database information, which may be stored in the map database 204 and/or the remote computing system 150, may form what is referred to herein as a “AV map data, “REM map data,” or “Roadbook Map data.” Thus, the one or more processors 102 may process sensory information (such as images, radar signals, depth information from LIDAR or stereo processing of two or more images) of the environment of the vehicle 100 together with position information, such as GPS coordinates, the vehicle's ego-motion, etc., to determine a current location, position, and/or orientation of the vehicle 100 relative to the known landmarks by using information contained in the AV map. The determination of the vehicle's location may thus be refined in this manner. Certain aspects of this technology may additionally or alternatively be included in a localization technology such as a mapping and routing model.

### III. Safety Driving Model

Furthermore, the safety system 200 may implement a safety driving model or SDM, which may be utilized and/or executed as part of the ADAS system as discussed herein. By way of example, the safety system 200 may include (e.g. as part of a driving policy) a computer implementation of a formal model such as a safety driving model. A safety driving model may include an implementation of a mathematical model formalizing an interpretation of applicable laws, standards, policies, etc. that are applicable to self-driving (e.g., ground) vehicles. In some embodiments, the SDM may comprise a standardized driving policy such as the Responsibility Sensitivity Safety (RSS) model. However, the embodiments are not limited to this particular example, and the SDM may be implemented using any suitable driving policy model that defines various safety parameters that the AV should comply with to facilitate safe driving.

For instance, the SDM may be designed to achieve, e.g., three goals: first, the interpretation of the law should be sound in the sense that it complies with how humans interpret the law; second, the interpretation should lead to a useful driving policy, meaning it will lead to an agile driving policy rather than an overly-defensive driving which inevitably would confuse other human drivers and will block traffic, and in turn limit the scalability of system deployment; and third, the interpretation should be efficiently verifiable in the sense that it can be rigorously proven that the self-driving (autonomous) vehicle correctly implements the interpretation of the law. An implementation in a host vehicle of a safety driving model (e.g. the vehicle 100) may be or include an implementation of a mathematical model for safety assurance that enables identification and performance of proper responses to dangerous situations such that self-perpetrated accidents can be avoided.

A safety driving model may implement logic to apply driving behavior rules such as the following five rules:
Do not hit someone from behind.
Do not cut-in recklessly.
Right-of-way is given, not taken.
Be careful of areas with limited visibility.
If you can avoid an accident without causing another one, you must do it.

It is to be noted that these rules are not limiting and not exclusive, and can be amended in various aspects as desired. The rules thus represent a social driving “contract” that might be different depending upon the region, and may also develop over time. While these five rules are currently applicable in most countries, the rules may not be complete or the same in each region or country and may be amended.

As described above, the vehicle 100 may include the safety system 200 as also described with reference to FIG. 2. Thus, the safety system 200 may generate data to control or assist to control the ECU of the vehicle 100 and/or other components of the vehicle 100 to directly or indirectly navigate and/or control the driving operation of the vehicle 100, such navigation including driving the vehicle 100 or other suitable operations as further discussed herein. This navigation may optionally include adjusting one or more SDM parameters, which may occur in response to the detection of any suitable type of feedback that is obtained via image processing, sensor measurements, etc. The feedback used for this purpose may be collectively referred to herein as “environmental data measurements” and include any suitable type of data that identifies a state associated with the external environment, the vehicle occupants, the vehicle 100, and/or the cabin environment of the vehicle 100, etc.

For instance, the environmental data measurements may be used to identify a longitudinal and/or lateral distance between the vehicle 100 and other vehicles, the presence of objects in the road, the location of hazards, etc. The environmental data measurements may be obtained and/or be the result of an analysis of data acquired via any suitable components of the vehicle 100, such as the one or more image acquisition devices 104, the one or more position sensors 105, the position sensors 106, the speed sensor 108, the one or more radar sensors 110, the one or more LIDAR sensors 112, etc. To provide an illustrative example, the environmental data may be used to generate an environmental model based upon any suitable combination of the environmental data measurements. Thus, the vehicle 100 may utilize the tasks performed via trained model(s) to perform various navigation-related operations within the framework of the driving policy model.

The navigation-related operation may be performed, for instance, by generating the environmental model and using the driving policy model in conjunction with the environmental model to determine an action to be carried out by the vehicle. That is, the driving policy model may be applied based upon the environmental model to determine one or more actions (e.g. navigation-related operations) to be carried out by the vehicle. The SDM may represent the driving policy model or, alternatively, may be used in conjunction (as part of or as an added layer) with the driving policy model to assure a safety of an action to be carried out by the vehicle at any given instant. For example, the ADAS may leverage or reference the SDM parameters defined by the safety driving model to determine navigation-related operations of the vehicle 100 in accordance with the environmental data measurements depending upon the particular scenario. The navigation-related operations may thus cause the vehicle 100 to execute a specific action based upon the environmental model to comply with the SDM parameters defined by the SDM model as discussed herein. In other words, the environmental model may be generated at least in part on sensor data received via the various sensors of the vehicle 100 as noted herein, and the applicable driving policy model may then be applied together with the environmental model to determine a navigation-related operation to be performed by the vehicle.

Iv. Conventional HDR Image Generation and Usage

High Dynamic Range (HDR) technology enhances the ability to capture images across different light intensities, from very dark to very bright, without losing detail in either extremity. The use of HDR imagers is particularly useful for scenarios in which light conditions may change rapidly or when capturing details in both brightly illuminated and shadowed areas is crucial. Thus, the use of HDR imagers may be particularly useful in vehicles that may implement AV and/or ADAS functionality, as HDR imagers are capable of capturing images that may be used for computer vision (CV) algorithms as the lighting within the driving environment may change across the same image.

Typically, an HDR image is produced by taking multiple separate (non-HDR) images of the same scene at varying exposure times, storing these separate images in a buffer prior, and then performing an HDR combination of the images. This method captures multiple images with varying exposures, each reflecting different levels of light exposure through the lens. These varying exposures are then processed by the image sensor, which merges them to form a complete image, mimicking the dynamic range of the human eye and effectively replicating what we naturally perceive. The process of generating HDR images in this manner is generally known, but suffers from drawbacks such as the time required to generate the non-HDR images with different exposure times as well as the time required to HDR combine the non-HDR images to create the final HDR image, which may be particularly detrimental for AV and ADAS applications in which such added latency may result in CV inaccuracies or even safety-related issues.

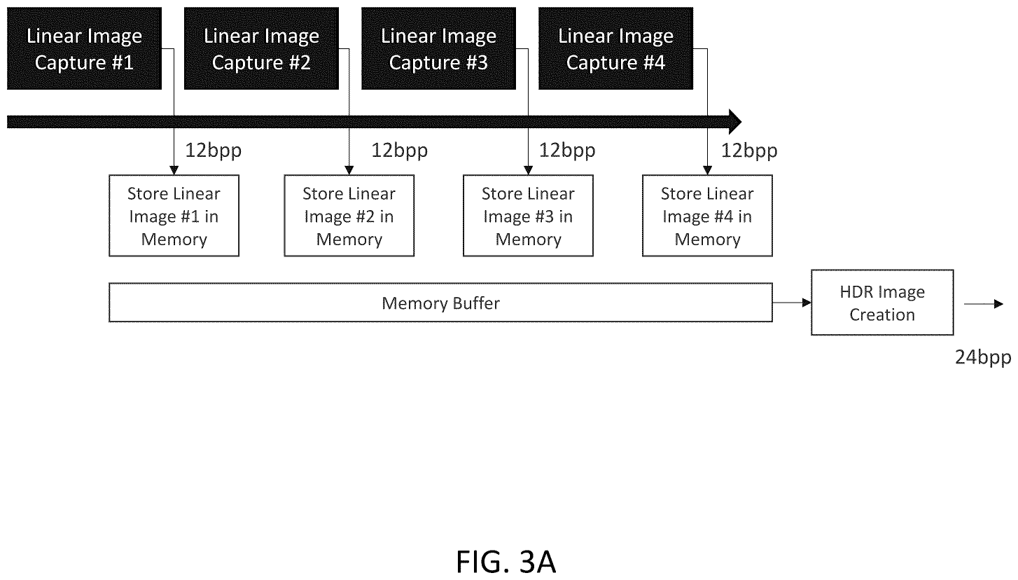

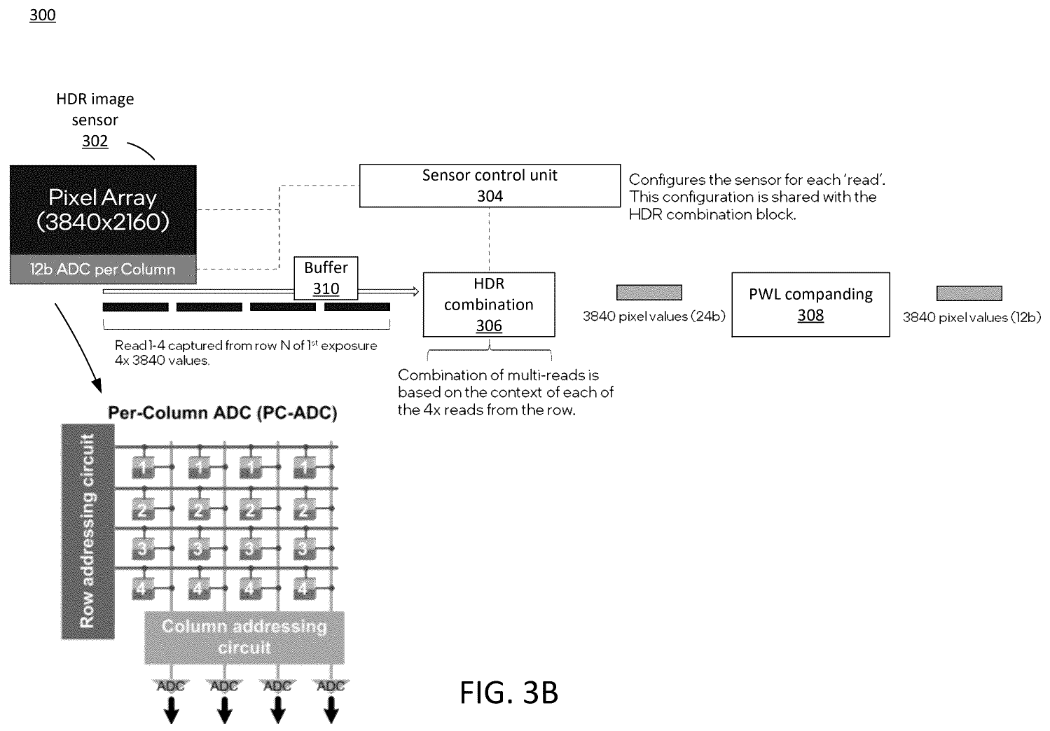

Such a conventional multi-frame HDR image generation technique is shown in further detail in FIG. 3A. As shown, a conventional HDR image is generated, in this example, by collecting four individual linear images in a memory buffer. The HDR image is then generated by combining these images to create an HDR image as shown. It is noted that the sensor's analog-to-digital conversion of the voltage level from the pixel typically limits the bit-depth of the linear images, generally to about 12 bits per pixel (12 bpp). Additionally, it is noted that with an example row length of 3840 pixels per row and 2160 rows, the size of the linear images in this example may be, for instance, about 8.3 Megapixels. Moreover, the 12 bpp represents the limit of data (0-4095 levels) that typically may be captured via an analog-to-digital conversion that measures the output signal of a pixel. The 24 bits per pixel (24 bpp) HDR image represents the signal levels of merging the linear image captures of saturation at different light levels.

Referring back to FIGS. 1 and 2, the one or more image acquisition devices 104 may form part of the safety system 200, and may be implemented as any suitable number and type of image-based sensors configured to acquire images within any suitable range of wavelengths, such as cameras, LIDAR sensors, etc. The one or more image acquisition devices 104 may be operated, monitored, and/or controlled via one or more components of the safety system 200, which may be implemented as part of an AV or ADAS system. For instance, the one or more processors 102, one or more of the processors 214A, 214B, 216, 218, etc. may communicate with and/or control the one or more image acquisition devices 104. This may include modifying the operating parameters of the one or more image acquisition devices 104 with respect to how images are acquired, modifying exposure values by adjusting the integration time and/or gain used to acquire images, monitoring the settings and/or operating parameters of the one or more image acquisition devices 104, etc.

The embodiments as discussed in further detail herein may be performed, for example, with respect to the vehicle 100 (e.g. via an ADAS or AV system thereof) utilizing the one more image acquisition devices 104 to acquire images, which may in turn be used to perform various vehicle-based functions. These vehicle-based functions are discussed in further detail below, and may include any suitable functions that are executed as part of an AV or ADAS for instance. As some illustrative examples, the vehicle-based functions may include detecting and/or classifying features and/or objects within a driving environment, using the classified features and/or objects to perform control-based functions such as vehicle navigation, issuing alerts, etc.

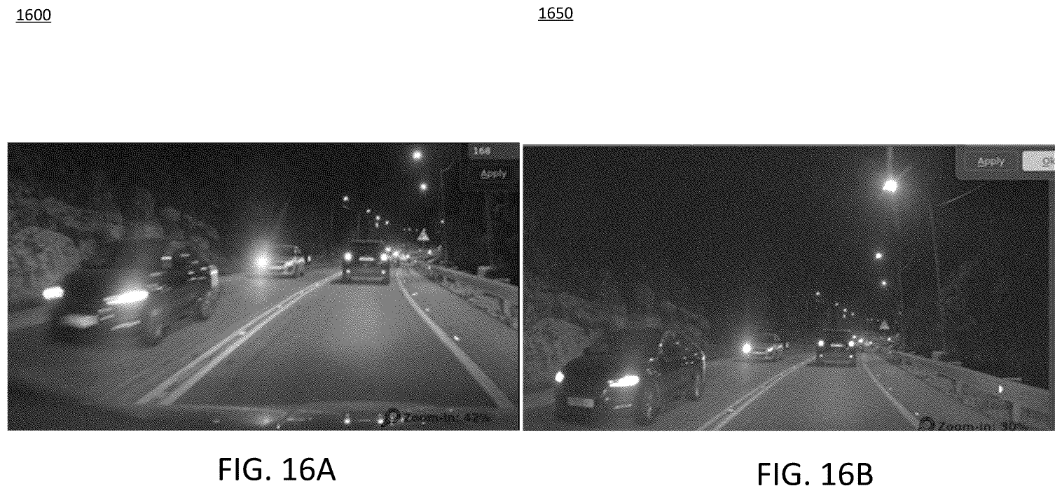

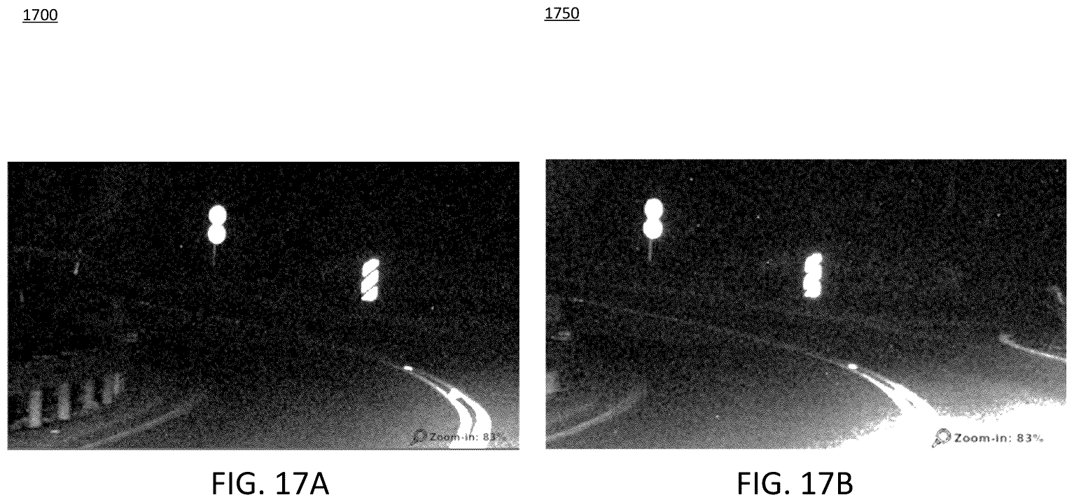

The embodiments further discussed herein focus primarily on the use of an HDR imager, and in such scenarios the HDR imager as discussed herein may comprise one or more of the one or more image acquisition devices 104. Thus, as part of the operation of the vehicle 100, the AV or ADAS system as discussed herein may adjust the sensor exposure value (e.g. the integration time, gain, etc.) of the HDR sensor to best identify objects in a scene. Such exposure adjustments will have positive and negative effects in each case. For example, in a dark scene where an exposure is adjusted to a long integration time and a high gain to detect people, the long integration may cause objects in the scene to become blurred (See FIG. 16A, as discussed in further detail herein). The opposite effect is also true, i.e. shortening the exposure to a short integration time and a low gain to avoid blur will limit the detection of objects in lower light (See FIG. 17A, as discussed in further detail herein). Therefore, the use of a single imaging sensor presents difficulties in that a compromise is required to ensure that objects are still detected within an acceptable time frame needed to generate the HDR images. The embodiments discussed in further detail herein address these issues by implementing an HDR imager having a modified operation to generate multiple HDR images having different exposure values, but with a reduced latency required to do so. The result is that HDR images of both long and high exposures may be generated in a much faster time frame that that of a conventional HDR imager.

To better describe the improvements of the HDR image generation as discussed herein, the process used for a conventional HDR image generation and the use of these generated images in an AV or ADAS system is first described with respect to FIGS. 3A-3B, 4A-4B, and 5-6. For example, FIG. 3B illustrates a conventional HDR imager operation, which obtains HDR data at the pixel level when generating an HDR image. The HDR imager 300 as shown in FIG. 3B may include an HDR image sensor 302 that is comprised of a pixel array, which includes a number of columns (3840 in this example) and a number of rows (2160 in this example).

The HDR imager 300 also includes a sensor control unit 304, which may be controlled and/or in communication with the AV or ADAS system of the vehicle 100 as discussed above. The AV or ADAS system, or both, may be alternatively referred to herein as an AV/ADAS system, as discussed in further detail below. In any event, the sensor control unit 304 may receive instructions, commands, configuration data, etc., from the AV/ADAS system of the vehicle 100, and in turn control the operation of the HDR image sensor 302 as discussed herein. The sensor control unit 304, the HDR combination block 306, and the Piece-Wise Linear (PWL) companding block 308 may each be configured as any suitable number and/or type of hardware components, software components, or combinations of these. For example, the sensor control unit 304, the HDR combination block 306, and the PWL companding block 308 may be implemented as any suitable number and/or type of processors, controllers, application specific integrated circuits (ASICs), field programmable gate arrays (FPGAs), as part of a system on a chip (SoC) associated with the HDR imager 300, etc.

The sensor control unit 304, the HDR combination block 306, and the PWL companding block 308 may be configured to execute computer-readable instructions to perform the various functions as discussed herein, or, alternatively, via hardware dedicated components. The various architectures and functions associated with the sensor control unit 304, the HDR combination block 306, and the PWL companding block 308 as discussed herein with respect to FIG. 3B may be executed in accordance with any suitable techniques, including those known to be used in accordance with such applications.

Thus, the HDR image sensor 302, the sensor control unit 304, the HDR combination block 306, and the PWL companding block 308 may form part of the HDR imager 300, which again may be associated with one of the one or more image acquisition devices 104 as noted above. To this end, the sensor control unit 304 may thus configure the HDR image sensor 302 for each read of the charge value(s) collected via a particular pixel for each exposure time, with the read values then being stored in a buffer 310 or other suitable memory. For example, the HDR imager 300 may implement, via the sensor control unit 304 in this manner, a multi-capture progressive readout scheme in which the HDR imager 300 generates the HDR data for a long integration exposure time from multiple reads of a single row of the HDR image sensor.

In this context, it is noted that the multiple reads of a single row are implemented due to recent developments in image sensors, which included advancements in the pixel that led to sufficient dynamic range being captured in a single pixel structure. These developments are generally due to the addition of “overflow” capacitors, which store charge that overflows from the photodiode once it has saturated. However, in older image sensors that do not implement these additional overflow capacitors, a different process is implemented to obtain the required HDR data for a row. In particular, such older image sensors first sample the row at a longer exposure time, and then the row is exposed at the second, shorter exposure time to capture the brighter area. As a result, the size of the memory buffer 310 as shown in FIG. 3B must be increased to buffer multiple rows until the second, shorter exposure may be captured, which also adds cost and/or reduces the space for other features in the CMOS imager. Thus, such older techniques may obtain a single HDR row by (1) capturing data from a “long exposure row,” (2) buffering the “long exposure row,” (3) capturing the data from the “short exposure row,” and then (4) combining the “long” and “short” images within an HDR combiner. However, such older techniques still suffer from the significant latency in generating both of the long and short HDR images as noted above, in addition to the need to increase the memory of the buffer 310.

As shown in FIG. 3B, the HDR image sensor 302 may also include for this purpose an analog-to-digital converter (ADC) per pixel column having any suitable bit resolution, such as for instance the 12-bit ADC as shown in FIG. 3B. The multiple reads per row may thus be performed by reading the output of the ADC value for each column in a row from the buffer 1012, which again may be read from different parts of a pixel such as a large photodiode and a small photodiode for instance, as determined by the sensor control unit 304.

To do so, the HDR image sensor 302 may also include a row addressing circuit and a column addressing circuit, as shown in FIG. 3B, each being controlled by the sensor control unit 304 for example and being configured to activate a specific row of the pixel array at a particular time such that the photodiodes in each pixel in the row may be read, as discussed in further detail herein. For instance, the pixel array may have an ADC assigned to each column as shown. Thus, for a row to be connected to that column, the row addressing circuit will connect the rows to the columns of ADCs.

Each pixel in the pixel array may comprise one or more photodiodes, each collecting a charge level over a specified integration time, which may correspond to the long and short exposure times as discussed herein. For example, each pixel may have two or more separate charge storage locations, which are typically of different sizes (capacitors, floating diffusion, etc.) and which may be connected to an in-pixel transistor. For other pixel types, there may be two photo diodes such as a large and a small, with the small photodiode generally being about 1/16th the size of the large photodiode. In such scenarios, one or both of the photodiodes may also have two or more charge storage locations. As an illustrative example, for a pixel with a large and a small photodiode in which both photodiodes have a large and a small capacitive node to store electrons, such a pixel would include four locations that may be sampled (i.e. read), and each of the 4 photodiode read locations saturating at different respective light levels. As an example, a small capacitive node connected to a large photodiode will saturate first, whereas a large capacitive node connected to a small photodiode will saturate last.

As an illustrative example, for reading the pixels in a row, with each pixel including four different photodiode locations as noted above, an order of saturating from earliest to latest may be represented from (sample 1) large photodiode small capacitance, (sample 2) large photodiode large capacitance, (sample 3) small photodiode small capacitance, and (sample 4) small photodiode large capacitance. Therefore, per row, four vectors of data are generated which have a length of “w,” which represents the width of the pixel array. Thus, as an illustrative example, for an 8.3 MP image with dimensions of 3840 width (e.g. columns)×2160 height (e.g. rows), ‘w’ will be equal to the 3840 pixels. The charge level collected per integration time is thus a function of an amount of light that is received by the photodiodes of each individual pixel, with each photodiode typically being disposed at a different location within each pixel. Therefore, when a “read” operation occurs from the pixel array, the result is stored in the buffer 310 that is “w” pixels long. For each row reading operation, the HDR imager 300 progressively samples rows from the top row to the bottom row of the pixel array. And for each row sample, each pixel in the same row is sampled four times (one per photodiode location), thereby generating a 4×“w” vector set of data as described above. Of course, the use of 4× pixel reads as noted in this context is provided by way of example and not limitation, and conventional the HDR image sensor 302, as well as the embodiments discussed in further detail herein, may implement a greater or lesser number of pixel reads based upon the architecture and design of the pixels in the pixel array that is implemented.

In this way, for a particular exposure time (e.g. a “long” or “short” integration time), the charge value(s) from each pixel in the same row may be read multiple times, with each read being with respect to one of the different read locations within each pixel (e.g. defined by photodiode and capacitive node as noted above). These read values may then be accessed from the buffer 310 and used by the HDR combination block 306 to generate the HDR data for each particular pixel and exposure time on a per row basis. The data read from the buffer 310 in this manner, which is output by the per-column ADC as noted above, may be referred to herein as HDR exposure data. The HDR combination block 306 may thus receive, as inputs per pixel row that is read, the 4×“w” vector set of data as described above, and in turn generate an output 1×“w” data set. The input 4×“w” vector set of data thus allocates a number of bits per pixel in the row in this manner as a function of the bit resolution implemented by the column ADCs, with 12b per pixel being used for the 12b column ADC as shown in FIG. 3B. The HDR combination block 306 then allocates a “1×‘w’” memory location (e.g. in the buffer 310 or other suitable accessible memory location) for the row ‘w output by the HDR combination block 306 with a much higher bit per pixel (bpp), which is 24 bpp for the example as shown in FIG. 3B.

Again, the sensor control unit 304 configures the HDR image sensor 302 for each read, which may include setting specific parameters that are referred to herein as “context data,” and which specify a specific read configuration for each pixel read that is performed. These may include, for instance, a gain setting, reading an overflow value from an overflow capacitor, etc. Thus, the multiple reads may include measuring the charge received for each photodiode in a pixel for a specific read configuration as defined in accordance with a particular context, e.g. at a high gain, at low gain, a read of excess “overflow” from a photodiode into a capacitive node or a capacitor inside the pixel, etc. Each read is thus intended to represent a different range of light that may have reached the pixel photodiode(s) for a specific context, as established by the sensor control unit 304. The different reads may be performed via each photodiode in each pixel in the same row in a sequential manner with a delay between each read or, when an overflow capacitor is implemented, the different reads may occur concurrently. In any event, the reads of all read locations for each respective pixel within the same row may be completed within what is referred to in further detail herein as a single “row period.”

Again, the HDR combination block 306 is configured to generate the HDR data for each particular pixel and exposure time on a per row basis. To do so, the HDR combination block 306 is configured to normalize the multiple row samples (e.g. the 4×“w” vector set of data as described above), and these values are then companded. This normalization factor and overall process is generally referred to as “HDR gain.” As an illustrative example using the 4×“w” vector set of data as described above, the normalization for sample 1 may be “1×,” and for sample 2 the normalization factor may comprise a difference in capacitance between the large and the small capacitance as well as any “analog gain” applied to either pixel read. Thus, for sample 2, the large-to-small capacitance difference may for instance be ˜4× while a 4× gain may have been applied to sample 1. Therefore, the HDR gain for sample 2 may be ˜16×. For the sample 3, the difference in the large versus the small photodiode size may be ˜16×, so the total HDR gain of sample 3 would be 16×16 (sample 3/sample 2*sample 2/sample 1). Finally, for sample 4, the difference in the capacitance may be 16x. Therefore, the HDR gain of sample 4 may be 16×16×16. Or, in this case, 2\hat{ }12 (sample 4/sample 3*sample 3/sample 2*sample 2/sample 1).

In this way, for the 4×“w” vector set of data as described above, the HDR combination block 306 is configured express the normalization process as a multiplication by a vector of [1, 16, 256, 4096] to normalize the data. For each pixel value, the HDR combination block 306 is configured to decide (across all 4× normalized sample values (of that pixel)) which is the best value to use. To do so, the HDR combination block 306 is configured to make a selection to avoid noisy signals (e.g. the low range of an ADC less than a predetermined threshold value) and to ignore values close to or at the saturation value of the ADC, which may also be represented in terms of a predetermined threshold value. Thus, in most cases, the HDR combination block 306 may use e.g. only 1 or a combination of 2× (or more) normalized sample values for each pixel location considered, and then outputs a 24 bpp memory space of length “w,” as shown in the example of FIG. 3B.

In any event, for each pixel in the current row that is read, the combination of the multiple reads per pixel are then sent to an HDR combination block 306, as shown in FIG. 3B, which also has access to the context data via the sensor control unit 304 that was used with respect to the read configuration regarding when each pixel was read. Thus, the input to the buffer 310 comprises 1 of 4 (in this example) “w” rows that are 12 bpp. The data provided as an input to the HDR combination block 306 comprises the 4×“w” rows of 12 bpp, and thus the output of the HDR combination block 306 will be the HDR combined data 1×“w” of 24 bpp. For instance, if the reads were received from a row at separate read times, then the buffer 310 may be used to store older read values until the last read value has been captured from the row (“full pixel”). Such output HDR pixel values are typically in the range of 20-27 bits.

To provide another illustrative example, four reads of a single pixel (e.g. from different photodiodes in that pixel) may include “responsivity” values (digital_number_value/lux*s) of 1000 (read1), 100 (read2), 10 (read3), and 1 (read4). Thus, if the HDR imager 300 is designed with a 12 bit ADC per column, as shown in FIG. 3B, the maximum values of each read prior to the HDR combination block 306 will be ‘4095’ for each read. As another example, a bright light exposed to the HDR image sensor 302 may yield the read1, read2, and read3 being saturated such that the output value is ‘4095’. Containing this example, read4 is assumed to not be saturated and has a value of ‘500.’ The HDR combination block 306 may thus determine that the difference of ‘read1’ to ‘read4’ is 1000/1, and therefore the value of read4 will be 500 multiplied by 1000 (i.e. ‘read 1’/‘read4’), where the HDR pixel response will be 500,000 (i.e. 500*1000).

The PWL companding block 308 is configured to compress the HDR data values output by the HDR combination block 306 using a PWL transform in a process known as companding. Thus, the RAW data received from the sensor (e.g. the HDR data values) may be compressed by the PWL companding block 308 and then transmitted to a suitable components of the vehicle 100 (e.g. the AV or ADAS system of the vehicle 100 as noted above). The PWL companding block 308 may thus receive the 24 bpp value output by the HDR combination block 306 and generate (row-by-row) a companded 12b pixel value (in the current example) representing the pixel values across the entire row. The output of each companded HDR row may then be transmitted to the AV/ADAS system, which may linearize the 12b value to a 24b value. To do so, the AV or ADAS system may de-compand the 12b pixel data on a row-by-row basis using, for example, a PWL lookup table (LUT) before further processing, for instance, in accordance with CV applications.

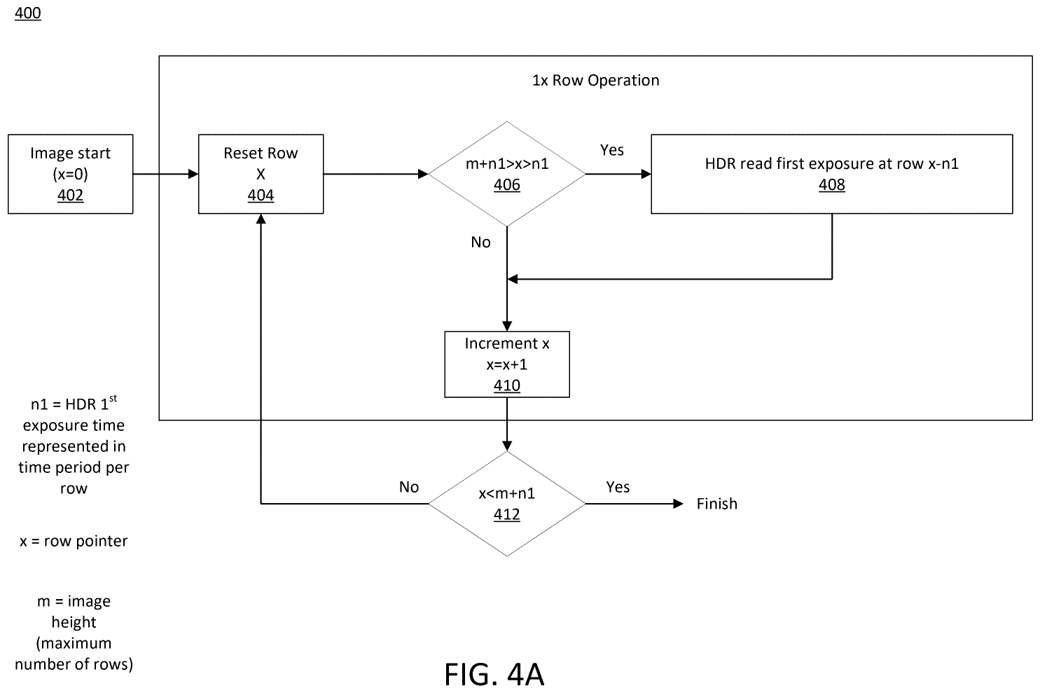

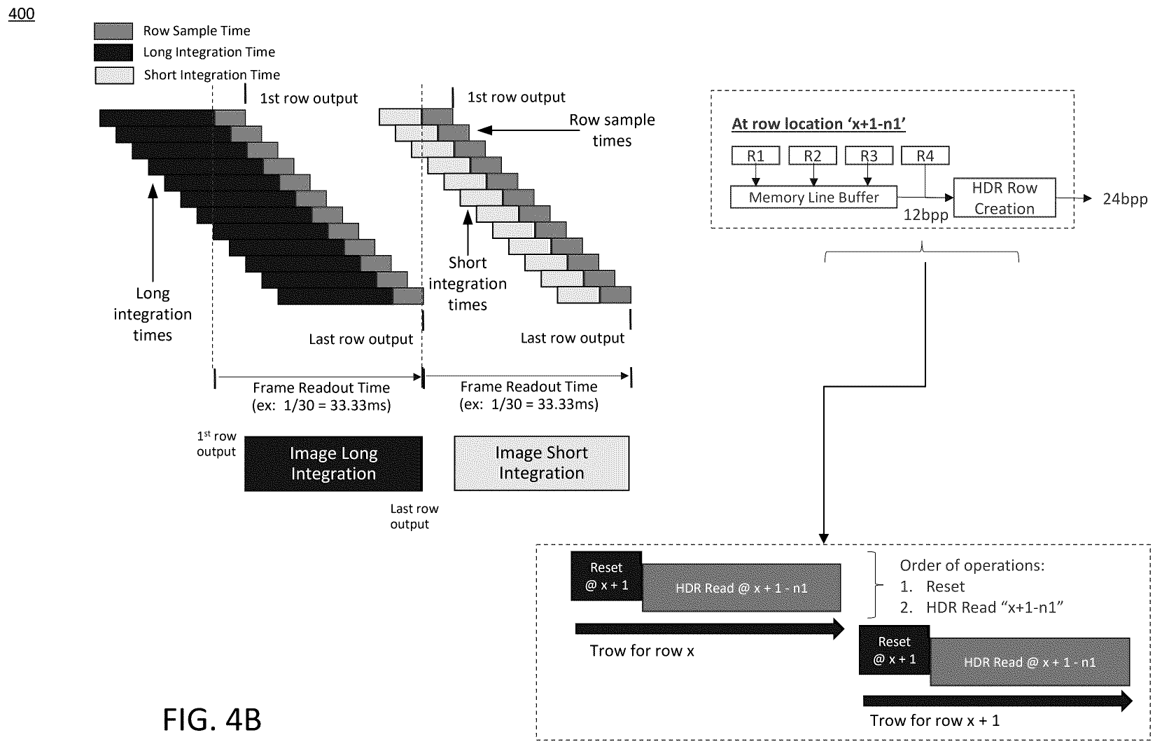

Again, the pixels of each row may be read together during a time period that is referred to herein as a row period. This process is further described below with respect to FIG. 4A, which illustrates a process flow 400 for a conventional HDR row level scan. FIG. 4A thus illustrates an order of readout from the 1st row (top of the pixel array of the HDR image sensor 302) to the last row (bottom of the pixel array of the HDR image sensor 302). The notation used with respect to FIG. 4A defines the total number of rows of the pixel array of the HDR image sensor 302 as “m” rows, and further defines a row pointer x that is incremented as each row is read. Prior to the read operation (block 408), each row is reset (block 404) such that each pixel's photodiode(s) are reset to a predetermined or default value that is associated with no electrons being received. Thus, after the reset operation (block 404) at each row, an integration time occurs in accordance with a particular exposure time, with the pixels being read by way of reading the accumulated charge value (e.g. output via the per columns ADCs) from the photodiode(s) in each pixel upon expiration of this integration time period.

The separation between each row being reset and being read is defined in terms of “n1,” which represents the exposure time represented in terms of a time period per row. This ensures that reading the first row (when x=0) occurs only after finishing the full HDR exposure of that row. As a result, and with respect to the first row being read, it is assumed that a delay time period has passed to ensure that the first row has completed a full integration time period in accordance with the corresponding exposure time. After this has occurred, the next row may then be progressively read as soon as the read for the previous row has been completed. It is noted that because the iterations shown in FIG. 4A are at the “read-time” resolution, the exposure time n1 is obtained as the ratio of (exposure time/read time). It is noted that in this context the “read-time” includes the time required for the individual reads of the pixel (e.g. the four read locations as discussed above) to store the 4×‘w’ information needed to produce an HDR row of length ‘w’. For example, if the row read time Trow (the read time to read a full exposure row) is 10 us and the exposure time is 15 ms, the value of n1 will be 1500 (i.e. 15000/10).

Thus, the process flow 400 begins at the image start block 402, and each row is then reset (block 404). Thus, after each row reset (block 404), a determination is first made (block 406) with respect to whether the condition of (m+n1>>>n1) is true meaning that the first row in the image has achieved the HDR exposure time of the value “n1” exposure rows. This includes determining, based upon “x>n1,” whether a row-read has been completed at the location of “x−n1”—where “x−n1” is the location of the row that has completed the exposure of “n1” (denoted in row periods). If the decision at block 406 is “no,” then no HDR read occurs, and the row pointer is incremented (block 410) and the next row is read, and so on, with the pixels in the next row being reset (block 404) in each case, restarting the integration time for the next row. In the same process where the decision at block 406 is “yes,” the next corresponding row read (block 408) is initiated before incrementing the row location “x” (block 410). The process flow 400 thus continues until the condition (x<m+n1) is true (block 412), which means that all rows of the intended HDR image have been read. Thus, at the completion of each row read in block 408, the reads from the different read locations within the pixel (of length ‘w’) are sent to the HDR combination block 306 to create an HDR row of ‘w’. Then, that particular row will be sent through the rest of the imaging path as an output. In other words, the HDR imager 300 does not store the data for the entire frame.

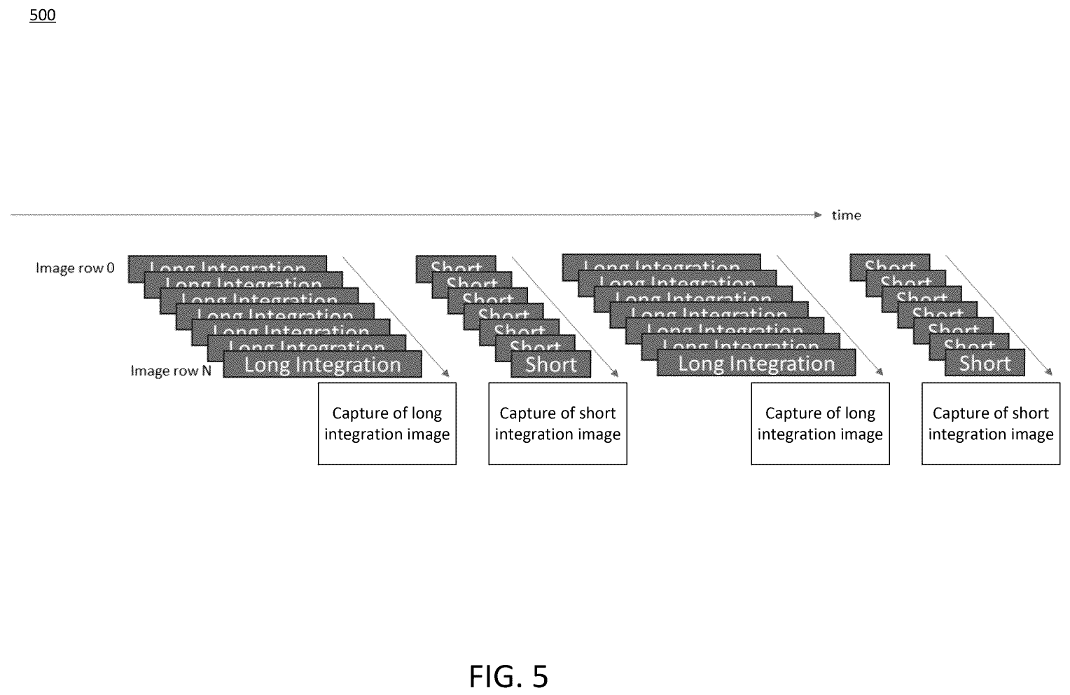

With this process in mind, if HDR images are to be captured with two separate exposures, the HDR imager 300 needs to generate two separate HDR images in a sequential manner. Thus, the HDR imager 300 may generate separate HDR images over time, each having different exposure times, as shown in FIG. 5. In other words, FIG. 5 illustrates a progressive readout technique implemented by a conventional HDR imager, such as the HDR imager as shown in FIG. 3B for instance. However, the generation of each separate HDR image in this manner requires the process flow 400 as shown in FIG. 4A to be completed for each image. For example, each row may be read in accordance with a longer exposure (e.g. integration time) to generate a longer exposure HDR image, and then each row may be read in accordance with a shorter exposure (e.g. integration time) to generate a shorter exposure HDR image, and so on as additional HDR images are generated.

FIG. 4B illustrates a conventional line-by-line HDR image generation technique. The line-by-line HDR image generation technique as shown in FIG. 4B may correspond to that implemented via the process flow 400 as shown in FIG. 4A, and may be implemented via the HDR imager 300 as shown in FIG. 3B for instance. It is noted with reference to FIG. 4B that the Trow time period is defined by the image size and frame rate. For example, for an 8.3 MP (3840×2160) image created at 30 fps, the frame rate will be 1/30 s (33.3 ms) where each Trow would be 15.43 us/row (=33.33/2160). This is assuming there is no “rest time” between the HDR images. Thus, and as shown in FIG. 4B, for a conventional line-by-line HDR image generation process, each row read includes a single HDR read of the HDR exposure data R1, R2, R3, R4, which again may correspond to multiple read locations of each pixel within the same row.

The HDR exposure data R1, R2, and R3 may thus be stored in the memory line buffer as shown prior to their (per row) combination with the HDR exposure data R4 via the HDR row creation block as shown. Thus, the memory line buffer as shown in FIG. 4B may be identified with the buffer 310 as shown in FIG. 3B, whereas the HDR row creation block may be identified with the HDR combination block 306. This single HDR read is first performed row-by-row for the longer integration time HDR image and then, in the next image frame, for the shorter integration time HDR image, as shown in FIG. 4B. This process results in the long and short integration time HDR images being generated having a time offset equal to the frame readout time, which is a function of the 30 fps frame rate and is shown as 33.33 ms in FIG. 4B. Again, the 12 bpp value as shown represents the limit of data (0-4095 levels) that typically may be captured by an ADC measuring the output signal of a pixel, whereas the 24 bits per pixel (24 bpp) represents the signal levels of the merging of the various linear captures of different saturation levels.

FIG. 4B also illustrates an order of operations per row, which again includes a single HDR read. In this example, each row read is reset for a period of time (measured in n1 rows) prior to performing an HDR read of that row. Thus, a time offset is introduced that represents the time required for the reset row operation to be completed in each case, as represented by the vertical offset in FIG. 4B between the row rest and the row read as shown in FIG. 4B. The results of this conventional HDR image generation process is further described below with respect to FIG. 5.

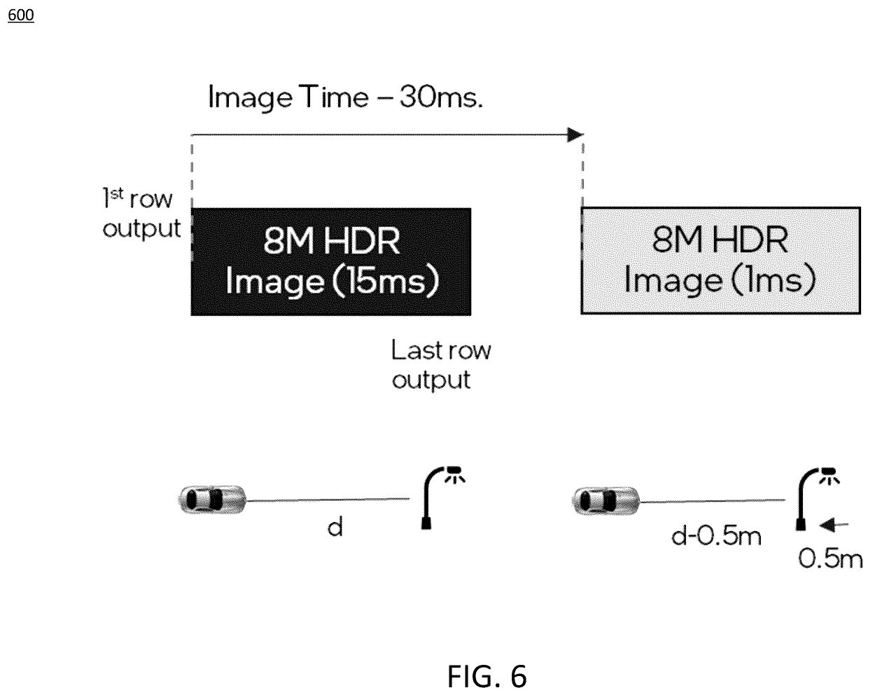

Thus, FIG. 5 illustrates that although the HDR imager 300 may be implemented to generate HDR images with different exposure values, doing so requires the next HDR image to be generated only after all rows of the pixel array of the HDR image sensor 302 have been read at the current exposure time. Thus, conventional solutions typically implement a serial exposure control in which the HDR imager 300 captures a full HDR image at a long exposure (e.g. 30 ms) followed by a short exposure (e.g. 1 ms) alternatively, as shown in FIG. 5. However, although two separate exposure images may be generated and used for a CV system in such scenarios, this introduces practical issues in their implementation. For instance, if a dark object may only be detected using a long exposure HDR image and is not visible in the short exposure HDR image, then the tracking of the dark object may only occur after the time required for two image frame periods. Thus, if a CV algorithm attempts to use both the long and short exposure HDR images to detect an object, this presents issues as there may be a significant difference (in time) between capturing the two images. This results in a difference in the scene appearance (e.g. objects position, orientation, occlusions etc.) in both images as well. An example of this issue is shown in FIG. 6, as 30 milliseconds has elapsed between the generation of two different exposure HDR images. For the example as shown in FIG. 6, the movement of an object is shown relative to a vehicle between two images acquired at 30 fps while the vehicle is driving at 50 km/h. FIG. 6 thus illustrates the difference in distance between the car and the lamp post between the generation of each of these HDR images.

Another conventional solution to utilize HDR images having different exposures in this manner is to utilize two separates synchronous HDR cameras. The output of both cameras may then be sent to the ADAS/AV CV processor. The images may be synchronized in time such that objects between the two different exposures can be easily compared. Although such solutions are possible, this adds considerable cost as a result of the additional camera.

V. HDR Image Generation with Reduced Latency

The embodiments discussed herein address the issues with such conventional solutions by implementing an HDR image generation technique in which a single HDR camera may generate two separate HDR images with different exposures, effectively functioning as two HDR cameras. It is noted in this regard that the embodiments described in further detail below should not be confused with a canonical HDR image that is generated from different linear exposures, such as those discussed above. That is, and as shown in FIG. 3A, conventional multi-exposure HDR generation techniques may capture multiple “linear” images and store these in a “frame buffer.” Then an “HDR combination” may be performed on the multiple linear images to create the HDR image. Alternatively, conventional multi-exposure HDR generation techniques may capture each set of linear row reads (from the same row location) to create an HDR row, and which the combination of all HDR rows will create an HDR image, as discussed with respect to FIGS. 4A-4B and 5.

However, the embodiments as discussed in further detail herein may perform “x linear reads” to create an HDR row for a first HDR image and then a second set of “x linear reads” to create an HDR row for the second HDR image. To do so, the embodiments as described in further detail herein utilize an HDR imager that may read two different rows, each having a different exposure value, within a single row operation. In other words, the embodiments as discussed in further detail below may concurrently read the pixel values from two different rows of an HDR image sensor, with each row being identified with a different exposure time. Thus, and as discussed in further detail below, the two HDR images may be generated for a single image frame and be time offset with respect to one another by a time period that is no greater than the shorter exposure time (e.g. the HDR exposure time of the second HDR image, as discussed in further detail herein).

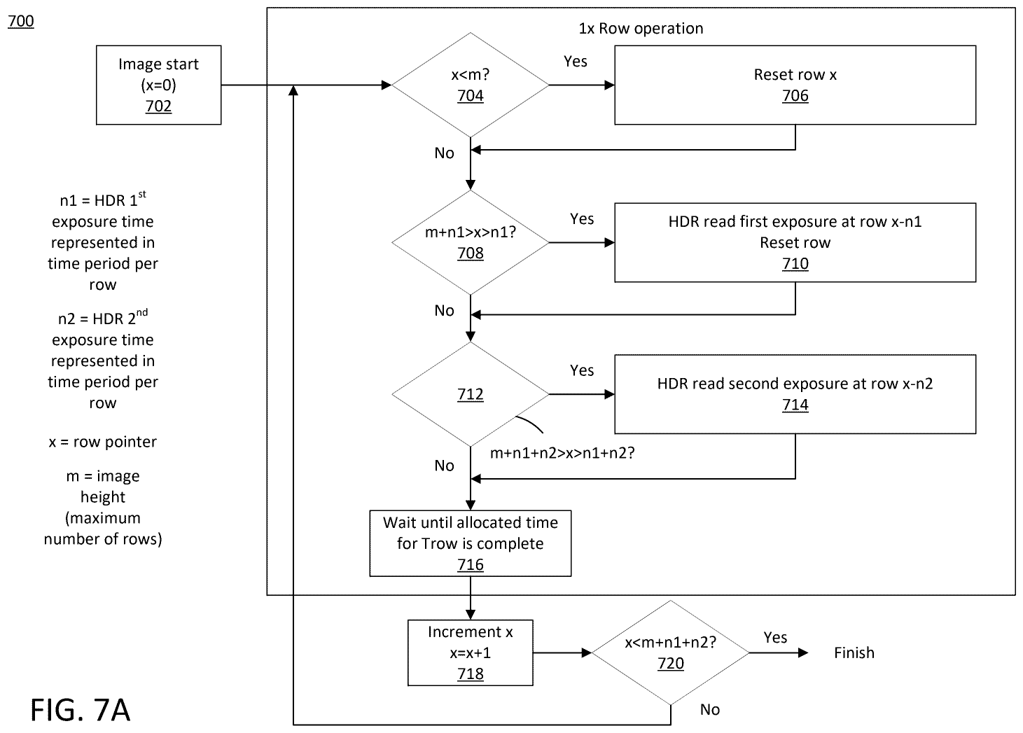

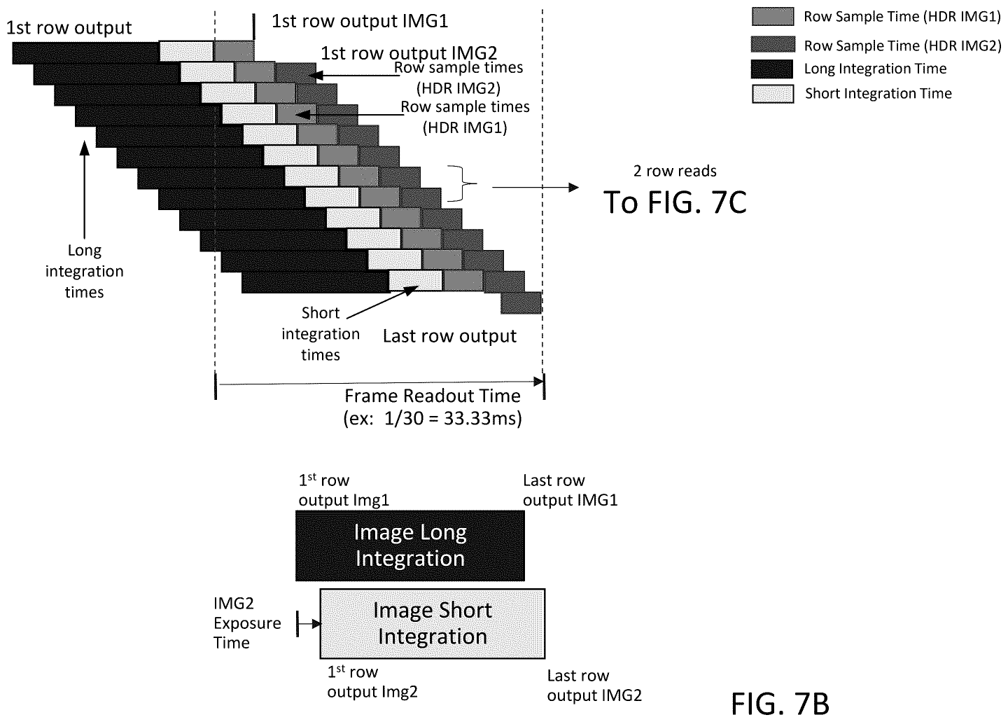

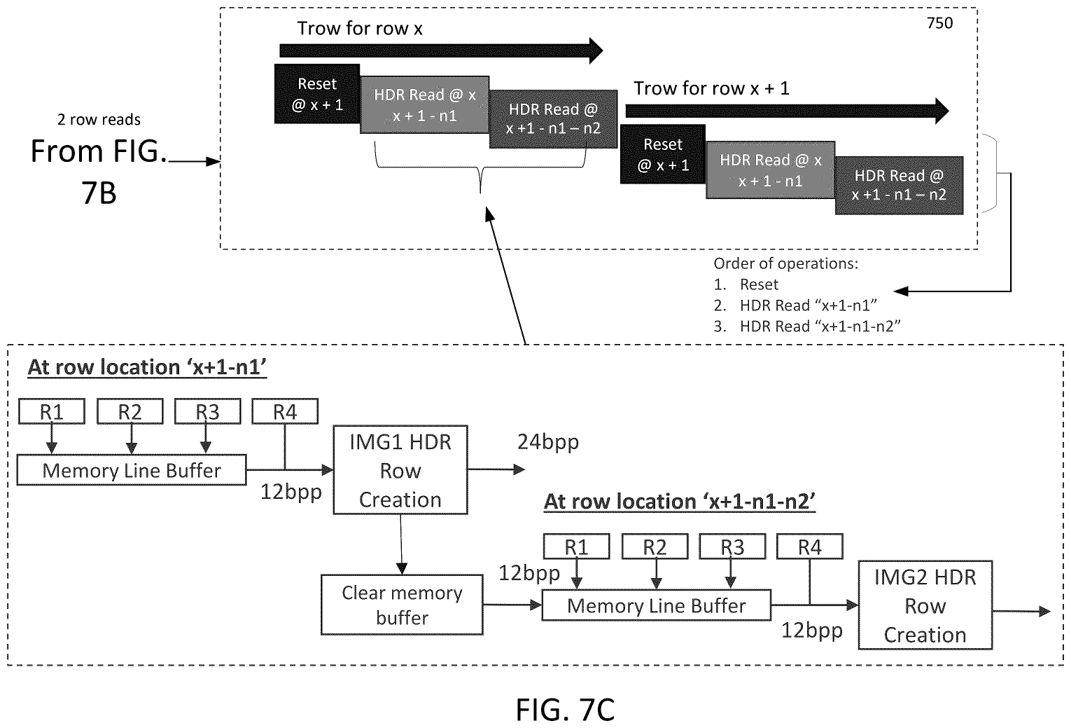

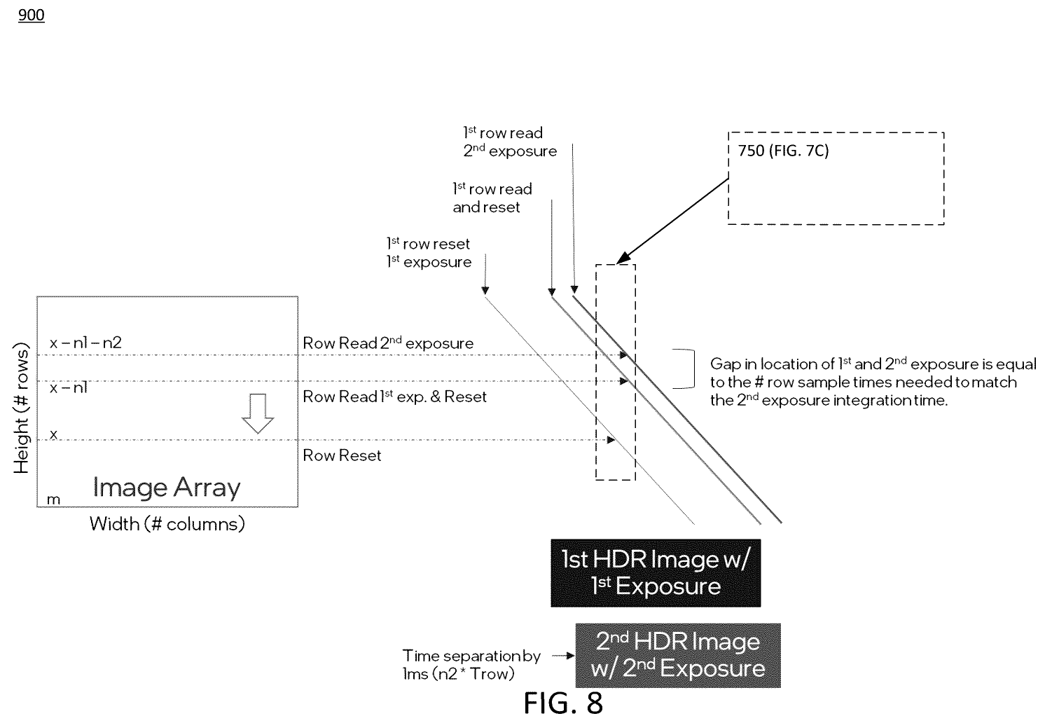

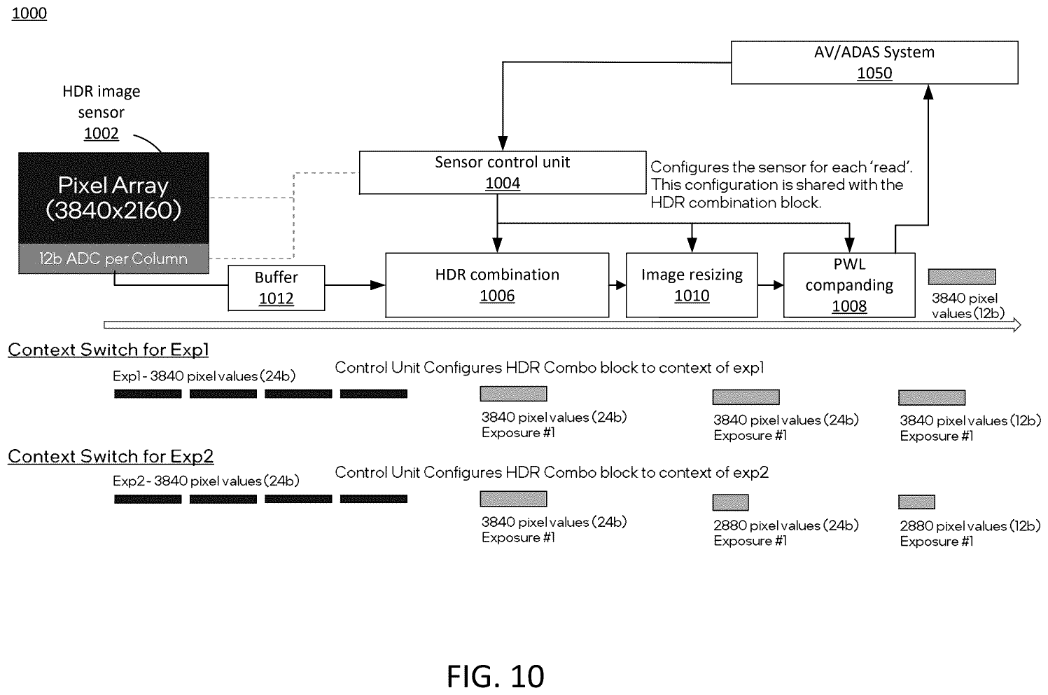

To do so, reference is now made to FIG. 7A, which illustrates a process flow 700 for performing two different HDR exposure reads in a single row time to facilitate the generation of two separate HDR images within a single frame time. The process flow 700 may be used in accordance with a similar architecture of the HDR imager 300 as shown in FIG. 3B, although the manner in which the reads are performed is modified for the process flow 700 compared to the process flow 400. Thus, the process flow 700 may be described with respect to the operation of the HDR imager 1000 as shown in FIG. 10, which contains several of the components as shown and described above with respect to the HDR imager 300 of FIG. 3B.

For instance, the HDR imager 1000 also includes an HDR image sensor 1002, which may include an HDR image sensor pixel array, as well as a sensor control unit 1004, an HDR combination block 1006, a PWL companding block 1008, and may optionally include an image resizing block 1010, with additional details regarding the resizing operations being provided below. The HDR image sensor 1002, the sensor control unit 1004, the HDR combination block 1006, and the PWL companding block 1008 may be configured to operate in a similar or identical manner as the HDR image sensor 302, the sensor control unit 304, the HDR combination block 306, and the PWL companding block 308, respectively, excepting for further differences in their operation as discussed herein. Additionally, the image resizing block 1010 may also be configured as any suitable number and/or type of hardware components, software components, or combinations of these. Thus, the sensor control unit 1004, the HDR combination block 1006, the PWL companding block 1008, and the image resizing block 1010 may be implemented as any suitable number and/or type of processors, controllers, application specific integrated circuits (ASICs), field programmable gate arrays (FPGAs), as part of a system on a chip (SoC) associated with the HDR imager 1000, etc. The various components of the HDR imager 1000 are shown in FIG. 10 as being connected by arrows, which may represent the flow of data and/or other suitable processing functions as discussed in further detail herein. These arrows may thus represent any suitable number and/or type of interconnections, links, ports, interfaces, etc., to facilitate the functions as described herein with respect to these components. Additionally, and as further discussed below, the HDR imager as shown in FIG. 10 includes an AV/ADAS system 1050, which may represent an AV system, an ADAS system, or both. The AV/ADAS system 1050 may be identified, for example, with the safety system 200 as discussed above and/or components thereof.

Thus, the AV/ADAS system 1050 may be referred to herein as performing various functions, which may include the execution of CV algorithms and/or the execution of various vehicle-based functions. This may be achieved, for example, via the one or more processors 102 of the safety system 200 executing instructions stored in a suitable memory, such as a local memory of the one or more processors 102, the one or more memories 202, etc. The AV/ADAS system 1050 may receive the generated HDR image from the HDR imager 1000 as an output of the PWL companding block 1008. Additionally, the AV/ADAS system 1050 may transmit controls, instructions, commands, etc. to the sensor control unit 1004, which may in turn control the operation of one or more of the HDR combination block 1006, the image resizing block 1010, and/or the PWL companding block 1008 via the transmission of control signals to these components, thereby causing the HDR imager 1000 to generate the HDR images in accordance with the embodiments as discussed herein.

In an embodiment, to achieve the reduced time offset between the generation of the HDR images as discussed above, the HDR imager 1000 includes a single digital data path, which processes data for the different row reads in parallel (e.g. concurrently) with one another and using a different configuration in each case. Thus, the configuration of the HDR image sensor 1002 is adjusted by the sensor control unit 1004 with respect to the processing performed via this digital path, as shown in FIG. 10 for each of the different HDR images. The digital path optionally includes an imager resizer block 1010, which may also be referred to herein as a raw resizer, and is configured to reduce the size of the RAW image output by the HDR combination block 1006. Thus, in embodiments in which the imager resizer block 1010 is implemented for this purpose for the smaller exposure HDR image, the system does not require the full resolution in the short exposure image, and thus the resolution may be reduced to save resources (memory, traffic, computation time etc.) Thus, the sensor control unit 1004 may reconfigure the processing (e.g. context switching) performed by the HDR combination block 1006, the imager resizer block 1010, and the PWL companding block 1008 between each HDR exposure read during a row period.

Thus, the sensor control unit 1004 controls the concurrent reads of each row of the pixel array as discussed above by configuring the different rows of the pixel array in each case and providing the context data to the HDR combination block 1006 to enable the concurrent generation of the different sets of HDR data for each row as they are read. The image resizing operation performed by the image resizing block 1010 may also function to reduce the size of the HDR image, as discussed in further detail below. The PWL companding block 1008 also functions to concurrently perform PWL companding of the HDR data for both HDR images data for each row as they are read, and the companded HDR data for both images is then concurrently transmitted to the AV/ADAS system 1050.

To do so, the sensor control unit 1004 may reconfigure the HDR image sensor 1002 to perform reads differently than the operation as discussed above with respect to the process flow 400. Thus, and as shown in FIG. 7A, in contrast with the process flow 400, the process flow 700 functions to concurrently read the pixel row location for a first exposure time and for a second exposure time, which results in the generation of HDR images having a timewise offset that is equal to the second exposure time. As was the case for the process flow 400, the exposure time n1 may represent the “long” exposure for the first HDR image, whereas n2 may represent the “short” exposure for the second HDR image) Thus, and as discussed with respect to the process flow 700, the exposure times n1, n2 are likewise expressed in terms of a time period per row, and thus need to be multiplied by the ratio of (exposure time/time to read an exposure row, or Trow) to convert between the HDR image exposure time and the time period per row. Thus the time period per row Trow may represent the time to complete the multiple pixel reads needed to create the HDR image row data, as discussed in further detail herein. In other words, the relationship between the exposure time and the time period per row (Trow) may be expressed in accordance with Equation 1 as follows:

Exposure time=(Time period per row*Trow) Eqn. 1:

For example, if a row time Trow (e.g. the time to read an exposure row) is 10 us/row, and the second exposure time is 1 ms, then the row location of the second exposure read will be the location of the first exposure read offset by 100 rows (n2=100). As a result, the gap in time between the output of the first row of the first exposure image and first row of the second exposure image will also be 1 ms. However, given the progressive manner in which the rows are scanned to provide the HDR data values, the first and the second HDR image may be generated for the same image frame having a time offset with respect to one another that is no greater than the second, shorter exposure time.

To achieve this result, the sensor control unit 1004 may, for example, reconfigure the HDR image sensor 1002 such that the row reads are performed in accordance with different exposure times and a corresponding context (e.g. different exposure settings). Thus, the process flow 700 indicates that, for each scenario in which 1× row operation block is entered and then exited, a single row read operation is executed for one or two rows of the HDR image sensor, each having different integration times. Thus, for the HDR image sensor 1002, which has 2160 rows, the operations within the 1× row operation block will be completed at least 2160 times to generate one or both HDR images. For instance, although the embodiments are discussed primarily herein in terms of the generation of the first and second HDR images nearly simultaneously (e.g. only offset by the exposure time of the shorter HDR image), this is by way of example and not limitation. In other embodiments, the first and second HDR images may alternatively be output consecutively. In any event, the operations within the 1× row operation block will be completed a number of times that is greater than the time that is denoted by the time of the second HDR (n2) exposure. That is, in the case of two consecutive HDR images being output, a time exists when the rows for the first HDR image are only read, as well as a time when only the rows of the second HDR image are read.

However, each row of the pixel array of the HDR image sensor 1002 is reset prior to reading a row at either integration time (e.g. at each different exposure). Thus, each row of the pixel array is first reset and, after completing the reset of each row, the condition x<m (block 704) is no longer true because x=m, as each row of the HDR image sensor has now been reset. Thus, each time the 1× row operation block is exited (regardless of whether a read operation of the pixel takes place), the row pointer x is incremented (block 718) and thus the process flow 700 includes resetting (block 706) the current row to be read until x=m (block 702), which means that each row has been reset. Again, the time between each row iteration is the Trow time (the time to read an exposure row) as described above.

Next, once each row in the HDR image sensor has been initially reset (block 704, no), the block 708 indicates that once the first integration time n1 has been completed (i.e. the first row has been reset with a “lead time” of at least n1 such that the condition m=n1>x>n1 is true, then the current row is read (block 710) at the fist, longer exposure time (e.g. integration time) at location x−n1. After the row is read, the row at location x−n1 is once again reset (block 710) such that the pixels in the row may be subsequently read in accordance with the shorter exposure time (e.g. integration time) once the “lead time” has at least n1 plus n2, as discussed further below with respect to the block 714.

Thus, each time the 1× row operation is exited and then re-entered, the decision at block 708 represents the next row being read due to the row pointer being incremented. This process then continues row-by-row until the condition at block 712 is also true. That is, the condition at block 712 is satisfied when m+n1+n2>x>n1+n2. In other words, the rows are reset from top to bottom until the reset number of rows are ahead of the first exposure time (m+n1>x>n1) and, upon this being the case, the first row is then read in accordance with the first exposure time n1. Again, until this is the case, however, the 1× row operation block will be iteratively executed by resetting (blocks 704, 706) each row and incrementing the row pointer (block 718) until the condition specified in block 708 (m+n1>x>n1) is met. Then, once the row pointer is also ahead of the second exposure time n2 (block 712, yes), the row at location x−n1−n2 is read again (i.e. the same row location was read ‘n2’ row periods prior) and now in accordance with the second exposure time (block 714). In other words, the decision at block 704 may represent a check regarding the row reset for the first HDR image. The decision at block 708 may represent a check regarding the read time of the first HDR image row plus the reset time for second HDR image row. Finally, the decision at block 712 may represent a check regarding the read of second HDR image row.

However, it is noted that the next frame operation may begin while a current operation as represented by the process flow 700 has not finished. Thus, while the outcome of block 708 may be false (e.g. “no”), the efficient usage of the HDR image sensor 1002 is that a previous image readout may still be occurring that is using the sensor read operations described in block 710. Moreover, while the outcome of block 712 may be false (e.g. “no”), a previous image readout may still be occurring that is using the sensor read operations described in block 714.

With respect to the process flow 700, the blocks 710, 714 each correspond to respective rows of the HDR image sensor 302 being read (e.g. the HDR exposure data being read from the per-columns ADCs as discussed above). In each case, these blocks represent “HDR reads” or multiple reads of each pixel within the row, as discussed above with respect to FIG. 3B. Again, these multiple reads may occur at the same time after the integration time has expired in each case, but be with respect to different photodiodes that may be associated with different portions of the same pixel in each row.

In any event, the reads may be performed by transferring the read HDR exposure data per pixel to the buffer 1012 or other suitable memory and then reading each of these values per pixel in each respective row. The HDR read operations represented in the blocks 710, 714 may also include calculating the HDR value per pixel via the HDR combination block 10006 as discussed above with respect to FIG. 3B, which functions to combine, per pixel, each of the photodiode reads based upon the context data. The time to read a full exposure row, or Trow, may thus be represented by the time required by the blocks 706, 710, and 714 to read these photodiode values per pixel in the same row, and to generate the corresponding per pixel HDR values. In this way, each of the long and short-exposure HDR images as discussed herein may be generated by iteratively reading (from different locations in the pixel array where electric charge can be measured) each row in the pixel array of the HDR image sensor 1002 per HDR image that is to be generated.

The block 716 thus ensures that a new row is not incremented until the read of the current row at both exposures has been completed. This may include, for instance, a predetermined time period that is established based upon the known operating and processing parameters of the HDR imager 300. Upon the last row being read, the result of incrementing this row then results in the condition x<m+n1+n2 (block 720) being met. In other words, once the current row is offset from the entirety of the rows and the total exposure time in term of row periods n1, n2, all rows have been read for each different exposure time. As a result, each HDR image may then be generated based upon the corresponding HDR values in each case. The generation of the HDR images in this manner may occur in accordance with any suitable techniques, including known techniques to do so.

In other words, within a single row period, the HDR imager 1000 is configured to read multiple captures of different response levels from the row to create an HDR representation of the data from those reads. Between each two row exposures, the HDR image sensor 1002 changes the context of the digital readout path. In this way, the offset in time between the read of the first row of the first HDR image capture and the first row of the second HDR image capture is equal to the exposure time of the second, shorter exposure image capture. As a result, the first and the second HDR image are generated (e.g. upon both frames having been fully received) having a time offset with respect to one another that is no greater than the second exposure time, as shown and further discussed below.

In other words, the first and second HDR images, each having a different exposure time, are generated by repeatedly reading the integrated HDR exposure data associated with the first HDR image and the integrated HDR exposure data associated with the second HDR image. These reads are thus performed with respect to different rows of the image frame and may be performed, for instance, concurrently with one another. This process may thus continue until the HDR exposure data of the first image and the HDR exposure data of the second image have been read from each row, in which case the condition at block 720 is satisfied.

In other words, the rows are read from the HDR image sensor 1002 in a progressive manner from the top row to the bottom row, with the progressive reading being performed such that the two rows being read are positioned within the image frame based upon the shorter exposure time of the second image. Additionally, the HDR exposure data for the first, longer integration time image is read a predetermined time after the row reset is performed for each row and is based upon the exposure time of the first image (e.g. n1). Furthermore, the time offset between the two rows being read may represent a predetermined (e.g. fixed) time that is based upon the second exposure time (e.g. n2). The time periods between the resetting of the rows, reading the row for the longer HDR exposure data, and reading the row for the shorter HDR exposure data may thus be iteratively performed in accordance with the process flow 700 such that the offset time values are maintained in this manner between row resets and row reads as the rows of the image frame are progressively read.

For further clarity, reference is now made to FIGS. 7B and 7C, which illustrate additional detail with respect to the timing of the HDR reads per row as described above with respect to the process flow 700. FIGS. 7B and 7C illustrate a line-by-line HDR image generation technique in accordance with embodiments of the present disclosure. The line-by-line HDR image generation technique as shown in FIGS. 7B and 7C may share some of the same processes as discussed with respect to the conventional line-by-line HDR image generation technique as shown in FIGS. 4A and 4B, with differences in their operation being described in further detail below.

The line-by-line HDR image generation technique as shown in FIGS. 7B and 7C may correspond to that implemented via the process flow 700 as shown in FIG. 7A, and may be implemented via the HDR imager 1000 as shown in FIG. 10 for instance. Thus, the memory line buffer as shown in FIG. 7C may be identified with the buffer 1012, whereas the IMG1 and IMG2 row creation blocks as shown in FIG. 7C may be identified with the HDR combination block 1006.

It is noted with reference to FIGS. 7B and 7C that the Trow time is once again defined by the image size and frame rate, as was discussed above with respect to FIGS. 4A and 4B. For example, for an 8.3 MP (3840×2160) image created at 30 fps, the frame rate will be 1/30s (33.3 ms) where each Trow would be 15.43 us/row (=33.33/2160). This is also assuming there is no “rest time” between the HDR images. However, and as shown in FIGS. 7B and 7C, in contrast with the line-by-line HDR image generation process described with respect to FIGS. 4A and 4B, in which a single HDR read is performed per image frame time, the embodiment as shown in FIGS. 7B-7C illustrate a process in which concurrent HDR reads may be performed for all rows of the pixel array within the same image frame time. For instance, and as shown in FIG. 7B, all HDR reads are performed with respect to all rows of the pixel array within the frame readout time of 33.33 ms. This allows for the long and short integration time HDR images to be output offset from one another by only the exposure time of the shorter HDR image as shown.

FIG. 7C illustrates additional detail with respect to the concurrent HDR reads that are performed at different rows of the pixel array during the image frame time. As shown in FIG. 7C, two different row locations are defined that are offset from one another within the pixel array, as shown in FIG. 8 and discussed in further detail below. One of these row locations is defined as “x+1−n1,” which may be identified with the row “x−n1” as shown in FIG. 8 and represents the HDR row read for the first, longer exposure HDR image. The other of these row locations is defined as “x+1−n1−n2,” which may be identified with the row “x−n1−n2” as shown in FIG. 8, and represents the HDR row read for the second, shorter exposure HDR image.

Thus, the order of operations as shown in FIG. 7C includes an initial reset of a respective row that is to be read, as discussed above with respect to the process flow 700. Then, within the same Trow period, separate HDR reads are performed at each of the two different rows of the pixel array, one HDR read for the longer integration time HDR image and another HDR read for the shorter integration time image. To do so, the data stored in the memory line buffer is cleared between these different HDR reads that are performed in separate row. Doing so allows the two different HDR row reads to be performed within the same Trow time period using a single HDR imager architecture while facilitating a near simultaneous output of the two HDR images, as shown in FIG. 7B. Although a single, “shared” buffer is shown in FIG. 7C, this is by way of example and not limitation. In other embodiments, the HDR imager 1000 may implement two such memory buffers, each being dedicated for the use of a respective HDR image. Doing so may reduce the latency of clearing the buffer between HDR reads by acknowledging a tradeoff in cost and added space.

For instance, and as shown in further detail in FIG. 8, the rows are initially reset row-by-row until the currently reset row is offset from the first row by the longer, first exposure time n1 (in terms of the time period per row). Thus, the offset between the currently reset row x and the currently read row in accordance with the first, longer exposure time is equal to the first exposure time n1 in terms of the time period per row. Moreover, the offset between the currently read row in accordance with the first, longer exposure time and the currently read row in accordance with the second, shorter exposure time is equal to the second exposure time n2 in terms of the time period per row. Still further, the offset between the currently reset row x and the currently read row in accordance with the second, shorter exposure time is equal to the sum of the first and the second exposure times n1, n2 in terms of the time period per row.

This process of resetting rows and reading rows in accordance with the first exposure time may then iteratively continue until the currently read longer exposure time row is offset from the first row by the shorter, second exposure time n2 in terms of the time period per row (based upon the row period). This process then continues, as discussed in further detail below, until all rows have been read in accordance with both the first and the second exposure values, thereby facilitating the generation of two separate HDR images that are offset in time by only the shorter exposure time.

The two HDR images generated in the manner may be utilized to perform any suitable vehicle-based functions by the vehicle 100. For example, the AV/ADAS system 1050 may implement the two generated HDR images to perform object classification. This may include any suitable type of object classification, such as those that implement CV algorithms, and may do so for instance based upon a comparison of the first and second HDR images for example. The vehicle-based functions may include any suitable type of control functions, object or feature classification, issuing warnings of other information based upon the classified objects and/or features, etc. The vehicle-based functions may include those that are known to be performed using HDR images, although the embodiments as discussed herein advantageously increase the accuracy of such vehicle-based functions given the generation of the two HDR images within a smaller time frame, meaning the two HDR images will represent very similar scenes given the reduction in the time offset between their generation.

For example, a CV system of the safety system 200 (e.g. performed via the AV/ADAS system 1050) may receive the two HDR images that are offset in time only by the time of the second, shorter exposure. This means that if the HDR image sensor 1002 is configured such that the second HDR exposure is small relative to the image frame time, then the objects observed in the first and the second HDR image will be separated by a small distance. This advantageously allows the CV system to compare the location of objects between the two images with much greater accuracy. The two images may thus provide complementary advantages to existing CV algorithms, e.g. low blur in the shorter exposure image and high visibility in the longer exposure image.

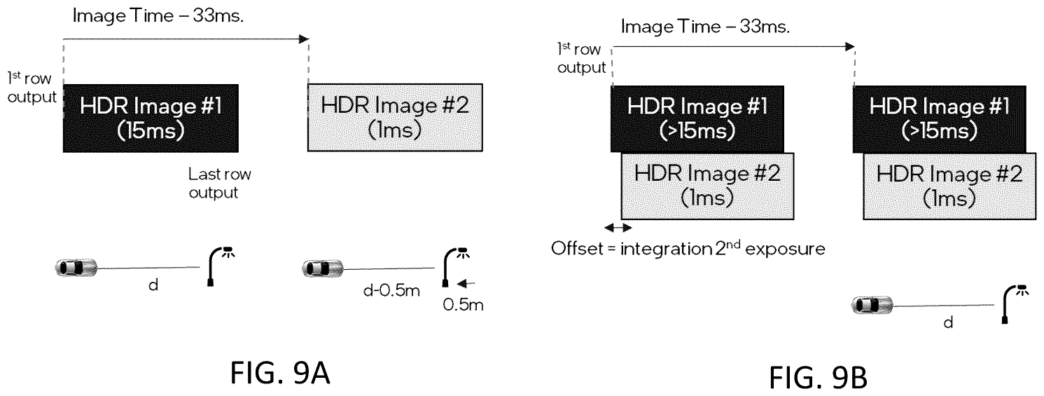

To provide an illustrative example, reference is now made to FIGS. 9A and 9B, which shows a scenario in which a vehicle is travelling at 50 km/hr, as was the case for the scenario as shown in FIG. 6. In the scenario as shown in FIG. 9A, the conventional process is implemented to generate the two different exposure HDR images, as discussed above with respect to FIGS. 4-6. Thus, the two images are offset in this example by 33 milliseconds due to the latency between the end of the first longer exposure HDR image first being generated and the shorter exposure HDR image being generated afterwards. During this time, the vehicle travels a distance of 0.5m between the generation of the first and the second HDR images. However, for the scenario as shown in FIG. 9B, the vehicle is also travelling at 50 km/hr, but the progressive scanning process as described above with respect to FIGS. 7-8 is implemented to generate the two HDR images. As a result, the two HDR images are offset in this example only by the smaller HDR exposure time of 1 millisecond, and thus the vehicle travels a distance of only 1.5 cm between generating the first and the second HDR images.

The first and second HDR images are shown in FIGS. 9A-9B having a longer exposure time of 15 ms and a shorter exposure time of 1 ms, although these are provided by way of example and not limitation. Nonetheless, it is noted that the use of a shorter exposure time for the second HDR image may be particularly useful for AV and ADAS applications given the ability to generate the two images offset in time by only the shorter exposure time value. To provide additional examples, one HDR image may be generated with an exposure time of at least 11 milliseconds, whereas the other HDR image may be generated with an exposure time no more than 3 milliseconds.

VI. HDR Image Generation with Image Size Reduction

To generate a shorter exposure HDR image with a limited latency after the output of the longer exposure HDR image, the embodiments described herein include additional modifications to the manner in which conventional HDR imagers operate to ensure that bandwidth is not increased by way of the transmission of both sets of companded HDR image data. That is, it is noted that conventional HDR imagers transmit the companded HDR data for both images serially, which requires significant system bandwidth in terms of the time needed to do so. In contrast, the embodiments described herein enable the transmission of the companded HDR data nearly concurrently in time (again, excepting for the small time offset of the exposure value of the smaller exposure HDR image). However, as a result, additional data bandwidth may be required compared to that used for conventional systems when transmitting each single HDR image. Thus, and as discussed in further detail below, the size and resolution of the shorter exposure image may be reduced via the image resizing block 1010 compared to the longer exposure HDR image. As a result, the serial bandwidth required to send the companded HDR data is not significantly increased compared to the conventional transmission of HDR data.

The resolution and size of the second, shorter exposure image may be reduced in this manner because objects that require a longer integration time and do not suffer from blurring artifacts are generally further from the vehicle. However, objects that benefit from the use of the shorter exposure times are those that would be prone to blurring given their proximity to the vehicle and, as a result, their faster movement with respect to the vehicle. Thus, given the proximity to the vehicle, less resolution is required by CV algorithms to perform detection, classification, etc. Thus, the shorter exposure HDR image Exp 2 may be reduced in size and resolution compared to the longer exposure HDR image Exp 1. Additional detail regarding the manner in which the HDR image size may be reduced to provide such benefits are provided in further detail below.

To provide some illustrative examples, the longer exposure image Exp 1 may comprise 3840×2160 pixels, whereas the shorter image Exp 2 may comprise a smaller number of pixels, such as the 2880×2160 pixels as shown in FIG. 10. The shorter exposure image Exp 2 may thus represent any suitable reduction in size compared to the longer exposure image Exp 1, which may include for example one-half, one-quarter, etc., the resolution of the longer exposure image Exp 1. Alternatively, the shorter exposure image Exp 2 may be reduced in resolution and size by any suitable manner compared to the longer exposure image Exp 1.

Thus, the image resizing block 1010 may, in accordance with various embodiments, reduce the bandwidth that is required for the data link between the PWL companding block 1008 and the AV/ADAS system 1050 to transmit both HDR images. For example, the image resizing block 1010 and the PWL companding block 1008 may receive context data from the sensor control unit 1004 in a similar manner as discussed herein with respect to the HDR combination block 306. This context data may instruct the image resizing block 1010 and/or the PWL companding block 1008 whether to modify the HDR images Exp 1, Exp 2 and, if so, the manner in which each should be modified as discussed herein. For instance, the image resizing block 1010 may be instructed via the context data to not modify the data output by the HDR combination block 1006 for the first, longer exposure image Exp 1. However, the context data may also instruct the image resizing block 1010 to reduce the image size of the second, shorter exposure image Exp 2 in accordance with the embodiments as discussed in further detail herein such that the output of the image resizing block 1010 is one-quarter (in this example) the size of the original, non-reduced image in terms of memory allocation. In this case, the added data required for the transmission of both HDR images Exp 1, Exp 2 to the AV/ADAS system is only a 25% increase from conventional techniques that require the transmission of two separate images over a much longer time period, as discussed above. Such embodiments may be particularly useful then the CV detection implemented for the shorter exposure HDR image may still operate using a lower resolution image. As further discussed below, the reduction in resolution and size of the shorter exposure image Exp 2 may provide the ADAS/AV system 1050 with additional flexibility with respect to the additional data it processes when receiving the two exposure HDR images.

Vii. HDR Image Generation with Bit-Per-Pixel (Bpp) Reduction

Additionally or alternatively, embodiments include an optional further reduction of the bits-per-pixel (bpp) of one of both of the HDR images Ex 1, Exp 2 from 12 bpp to 10 bpp as output by the PWL companding block 1008. For instance, the context data provided by the sensor control unit 1004 may also instruct the PWL companding block 1008 to perform a reduced bit per pixel companding for one or both HDR images Ex 1, Exp 2. For example, as the HDR exposure data may be read per pixel and per row as discussed above, and the HDR combination block 1006 may output the 24 bit HDR pixel values. The image resizing block 1010 may then reduce the size of the second, shorter exposure image Exp 2 from the data output via the HDR combination block 1006. Then, the PWL companding block 1008 may further reduce the bpp for one or both of the images Exp 1 and the reduced size image Exp 2. As an illustrative example, the PWL companding block 1008 may reduce the bpp from 12 bpp to 10 bpp versus as shown in FIG. 10. Of course, these bpp values are provided by way of example and not limitation, and the embodiments discussed herein may implement any suitable bpp for PWL companding, with any suitable reduction in bpp being performed for the shorter exposure HDR image and/or the longer exposure HDR image.

In various embodiments, the HDR imager 1000 may implement the resizing of the shorter exposure image in this manner by using an alternative means by which to perform per-color binning of the pixels of the shorter exposure HDR image Exp 2. To do so, the HDR combination block 1006 may generate the per row HDR pixel data as discussed above with respect to FIG. 7A, and the image resizing block 1010 may receive the HDR data output by the HDR combination block 1006 and generate the shorter exposure HDR image Exp 2 to have a lower resolution than the first HDR image Exp 1 by performing different color channel binning processes on different respective color channels of the shorter exposure HDR image Exp 2. Thus, the image resizing block 1010 may be implemented using the output of the HDR combination block 1006 to re-bin the pixels of the shorter exposure HDR image Exp 2, which are then input to the PWL companding block 1008 and transmitted to the AV/ADAS system 1050. The manner in which the PWL companding and transmission are performed may be the same for both the longer and the shorter HDR images, although the additional step of resizing of the shorter exposure HDR image Exp 2 may enable both bpp-reduced images to be transmitted using nearly the same bandwidth that would otherwise be implemented to serially transmit the two images in accordance with the conventional techniques discussed above (i.e. in which the HDR images are offset by a much longer time period).

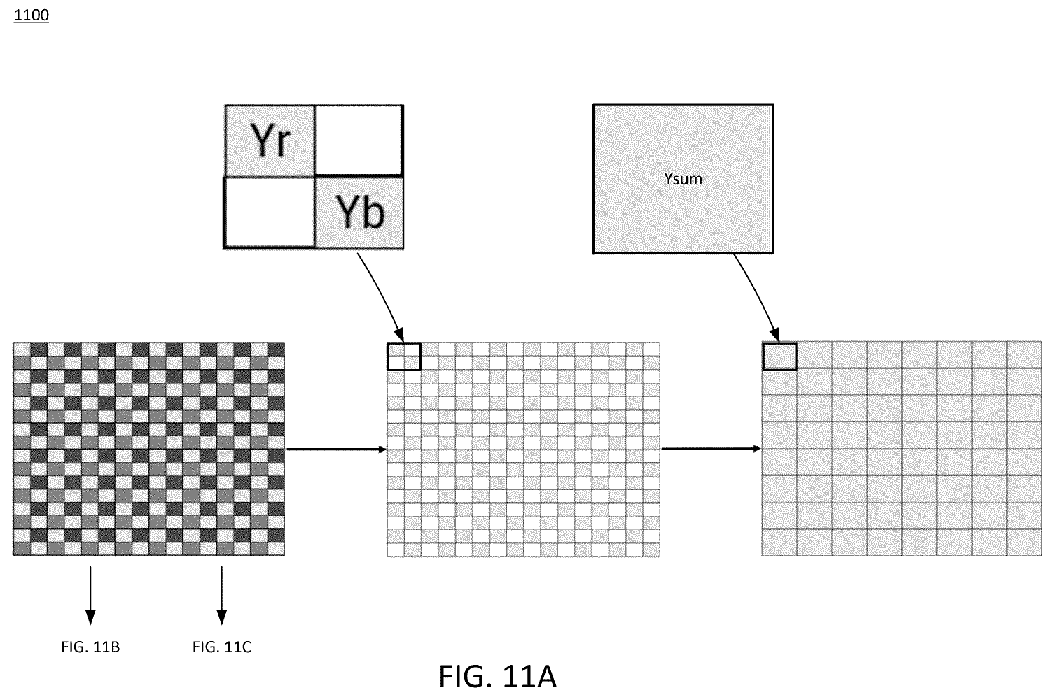

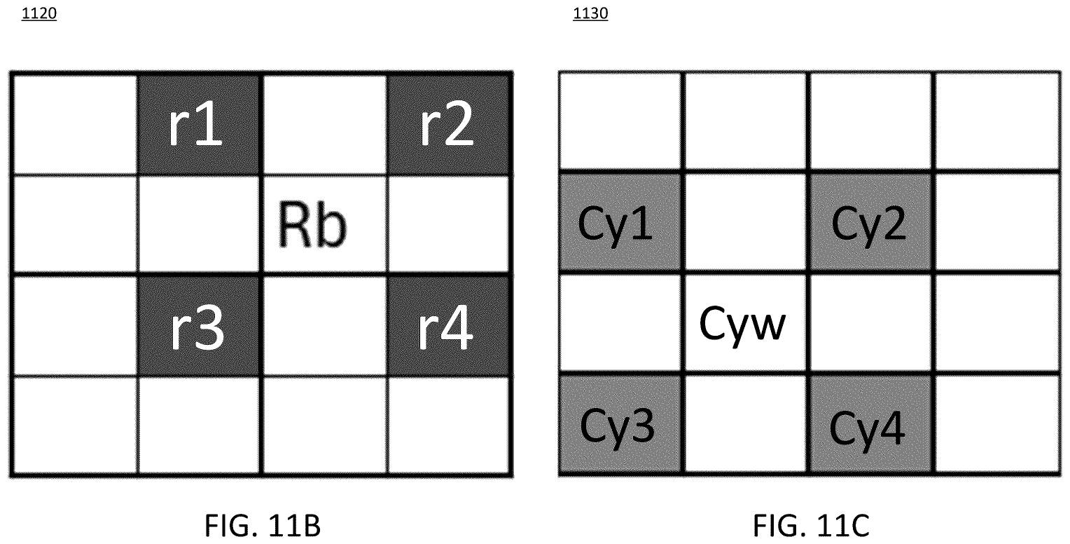

An alternative binning process in accordance with an embodiment is shown in further detail in FIGS. 11A-11C, 12A-12D, 13A-13B, and 14A-14B. It is noted that the embodiments are discussed herein are provided with respect to the use of a color filter array (CFA) implementing a RYYCy (red, yellow, yellow, cyan) Bayer pattern, which is recognized as being particularly advantageous in accordance with automotive imaging applications. Bayer patterns are generally known and implemented such that the CFA pattern placed on top of the pixels in an image sensor consists of four different color filters arranged in a repeating 2×2 grid, with the traditional Bayer pattern comprising RGGB (red, green, green, blue). However, the embodiments described herein are not limited to such examples.

For instance, and with reference to FIGS. 11A-11C, the shorter exposure HDR image Exp 2 may be resized by re-binning the 24 bit values output by the HDR combination block 1006 differently per three different color channels. For the RYYCy pattern as shown, the image resizing may be performed by using a different color binning process for the dominant color channel (yellow in this example), as shown in FIG. 11A, compared to the non-dominant color channels (red and cyan in this example), as shown in FIGS. 11B and 11C.

As noted above with respect to FIGS. 4 and 10, the HDR combination block 1006 may receive, as inputs per pixel row that is read, a 4×“w” vector set of data and generate an output 1×“w” data set. Again, the input 4×“w” vector set of data thus allocates a number of bits per pixel in the row in this manner as a function of the bit resolution implemented by the column ADCs. Thus, the image resizing block 1010 may utilize a memory space of input 4×HDR rows with 24 bpp of the input “w” spacing and output 1× row of “¾ w” spacing ( 2/4 yellow+¼ red or ¼ cyan).

Thus, using the 3840×2160 pixel array size as shown in FIG. 10, the 24b output for the long and short exposure HDR images Exp 1, Exp 2 (without resizing) have a size of approximately 8M. However, the use of the image resizing block 1010 may reduce the size of the short exposure HDR image Exp 2 to a 3M value (2M Y+1M R and Cy). The resizing calculations as discussed herein may be performed in the 24b space, and thus the input short exposure HDR image Exp 2 in this example is assumed to be 8 MP 24b and the output, reduced size image is assumed to be 3 MP 24b. The 8M long exposure HDR image Exp 1 and the resized 3M short exposure HDR image Exp 2 are still processed (row-by-row) by the PWL companding block 1008 in each case to generate a companded 12b pixel that is transmitted to the AV/ADAS system 1050, as noted above.

Thus, and with reference to the dominant color channel binning process as shown in FIG. 11A, values are shown with respect to the dominant colors Yr and Yb of a larger, original HDR image, and are assigned to individual pixels within a 2×2 pixel block. Thus, the dominant colors Yr and Yb may correspond to the pixel values of an HDR image that is generated using the output of the HDR combination block 1006 without performing the resizing operations as discussed herein. Thus, to perform the resizing operation, each pixel in the 2×2 pixel group is mapped to a single pixel value that has a size of the 2×2 pixel group (e.g. from two rows) and is assigned an average dominant color value “Ysum,” which is a function of the neighboring set of pixel values for the dominant colors Yr and Yb in the 2×2 pixel group. Thus, as the dominant colors are re-binned, the resulting re-binned dominant channel includes sets of re-grouped 2×2 pixel blocks as shown in the right side of FIG. 11A, thereby reducing the resolution of the image, with each pixel in the reduced size and resolution image having a single pixel value that is evaluated in accordance with Equation 1 below as follows:

$$Ysum = 0.5 * ( Yr + Yb ) \qquad Eqn . 1$$

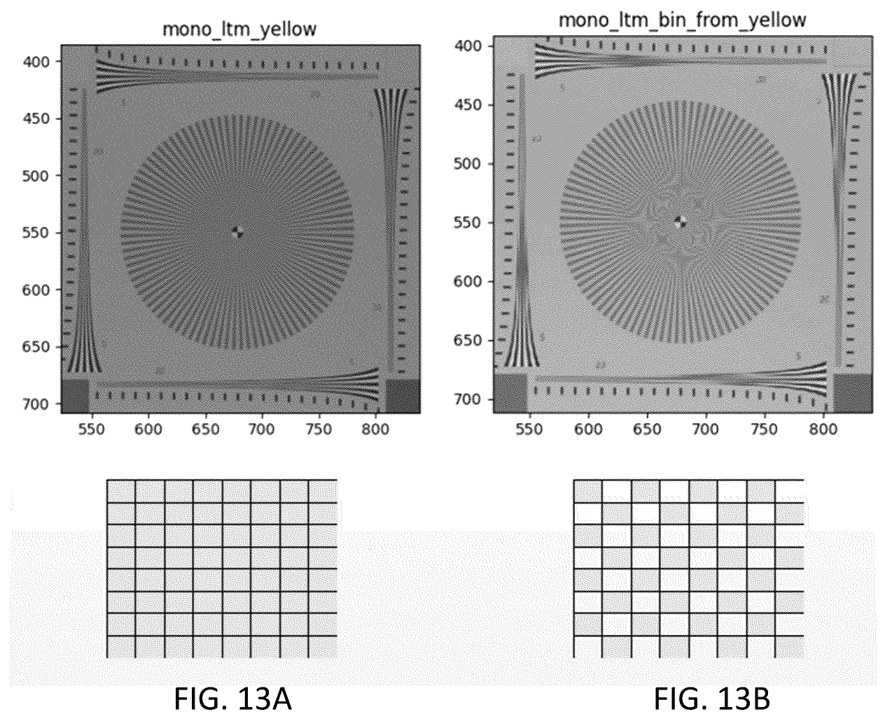

Furthermore, embodiments include the use of a “mono binning” of the pixels in the dominant color channel to perform image size reduction. Thus, the size and accompanying resolution of the dominant channel is reduced by half as a result of this binning process. It is noted that an example of the use of the mono binning process described above is shown in FIG. 13A, which is performed in contrast with conventional bayer binning as shown in FIG. 13B, which results in the introduction of artifacts. These artifacts are typically introduced by conventional binning processes as aliasing artifacts, which are caused by simply reducing the resolution of the pixel pattern. The use of the mono binning processes as described herein, however, maintain the data pixel values by encoding these values per channel and then providing these encoded pixel values in different parts of the reduced size image, as further discussed below.

Turning now to the non-dominant color channel binning processes as shown in FIGS. 11B-11C, values are shown in FIG. 11B with respect to the non-dominant red colors of a larger, original HDR image, which are assigned to individual pixels within a 4×4 pixel block. These four red pixel values may comprise the red pixel data values obtained via the row reading process as discussed herein, such that the four pixel values may correspond to an average of 4× pixels spread across 4× rows output by the HDR combination block 1006. Likewise, the values shown in FIG. 11C are with respect to the non-dominant cyan colors of a larger, original HDR image, which are assigned to individual pixels within a 4×4 pixel block and which also correspond to an average of 4× pixels spread across 4× rows output by the HDR combination block 1006.

Thus, the non-dominant colors red and cyan may correspond to the pixel values of an HDR image that is generated using the output of the HDR combination block 1006 without performing the resizing operations as discussed herein. Thus, for each of the non-dominant color channels as shown in FIGS. 11B-11C, to perform the resizing operation, each pixel in a 4×4 pixel group is mapped to a single pixel value that has a size of the 4×4 pixel group (e.g. from four rows) and is assigned a weighted sum of color values of a neighboring set of pixels. Thus, as the non-dominant colors are re-binned, the resulting re-binned non-dominant channel includes sets of re-grouped 4×4 pixel blocks, each having a single pixel value that is evaluated in accordance with Equations 2 and 3 below as follows:

$$Rb = ( a * r 1 ) + ( b * r 2 ) + ( c * r 3 ) + ( d * r 4 ) \qquad Eqn . 2$$

$$Cyw = ( a * Cy 1 ) + ( b * Cy 2 ) + ( c * Cy 3 ) + ( d * Cy 4 ) \qquad Eqn . 3$$

Thus, the size and accompanying resolution of the non-dominant channels is reduced by three-quarters as a result of this binning process.

The weighting equations Eqn. 2 and Eqn. 3 as shown above, which again are used for each of the non-dominant channels, and represent a spatial weighting scheme. This spatial weighting scheme allows for the reduced size image pixel data Rb and Cyw, respectively, to be encoded by adjusting the weighting contribution represented by the coefficients a, b, c, d based upon the pixel values of the neighboring pixels. To provide an illustrative example with respect to the red non-dominant channel, if the weighting coefficients a, b, c, d are equal, then the coverage of the encoded pixel value Rb, which represents a weighted color coverage, would be wider. However, if the weighing coefficient c (for pixel value r3) is reduced compared to the other weighting coefficients a, b, and d, then the spatial weighting for the pixel value r3 is moved closer to the upper right edge, i.e. away from the location of the pixel r3.

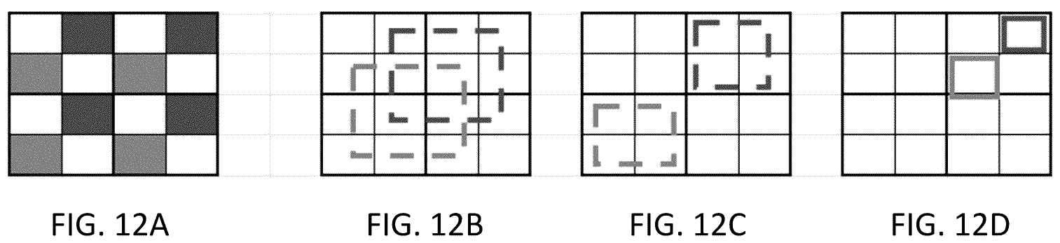

In other words, the configurable non-dominant channel binning control in this manner allows for the HDR imager 1000 to be configured to provide an optimal trade-off between resolution loss and avoiding spatial artifacts that may be seen from the lower resolution non-dominant colors. This may be particularly useful for a system designer using the HDR imager 1000 to determine how to select the non-dominant channels in the output image. This is further illustrated with respect to FIGS. 12A-12D.

For instance, FIGS. 12A-12D illustrate how the relative weighting of the non-dominant channels may appear based upon a different selection of the weighting coefficients a, b, c, d. The weighting as shown in FIGS. 12B-12D represent different combinations of weighting coefficients a, b, c, d, which may be selected to either increase the area of coverage and the SNR achieved by the combining process or, alternatively, to shift the relative center of the binned pixels farther away from each other. Thus, the weighting coefficients a, b, c, d may be selected based upon the particular conditions and the desired performance of the HDR imager 1000 in specific conditions. For instance, setting the weight to be equal provides the highest overlap in colors and the best low light performance.

For instance, FIG. 12A illustrates a sample 4×4 pixel block illustrating the location of the red and cyan colors in an original HDR image (e.g. an 8 MP short exposure time HDR image as discussed above). FIG. 12B illustrates the area of coverage and the center of the red and cyan pixels after equal 2×2 binning (e.g. by setting the weighting coefficients a, b, c, d equal to one another). FIG. 12C illustrates the area of coverage and the center locations of red and cyan pixels after a weighted binning process in which the weighting coefficients a, b, c, d are unequal. It is noted that FIG. 12C is provided for case of explanation, as the area covered is this example would also be with respect to a 3×3 pixel block, as was the case for FIG. 12B. FIG. 12D illustrates no binning, i.e. a single pixel being selected. This may be represented in terms of Equations 2 and 3, for instance, as the weighting coefficients a=1, and b=c=d=0.

In this way, the weighting used for the binning of the non-dominant color channels may be selected to reduce and adjust for any color artifacts that result from the binning processes. The selection of the weights in this manner may be static or, alternatively, be adjusted in accordance with any suitable number and/or type of predetermined conditions being satisfied. As an illustrative example, the mapping of the weighted sum of color values of the neighboring set of pixels may be selectively adjusted by modifying the weighting coefficients a, b, c, d for one or both non-dominant color channels in response to such conditions being met. These conditions may include, for example, the time of day, whether it is day or night, the speed of the vehicle, a location of the vehicle, etc.

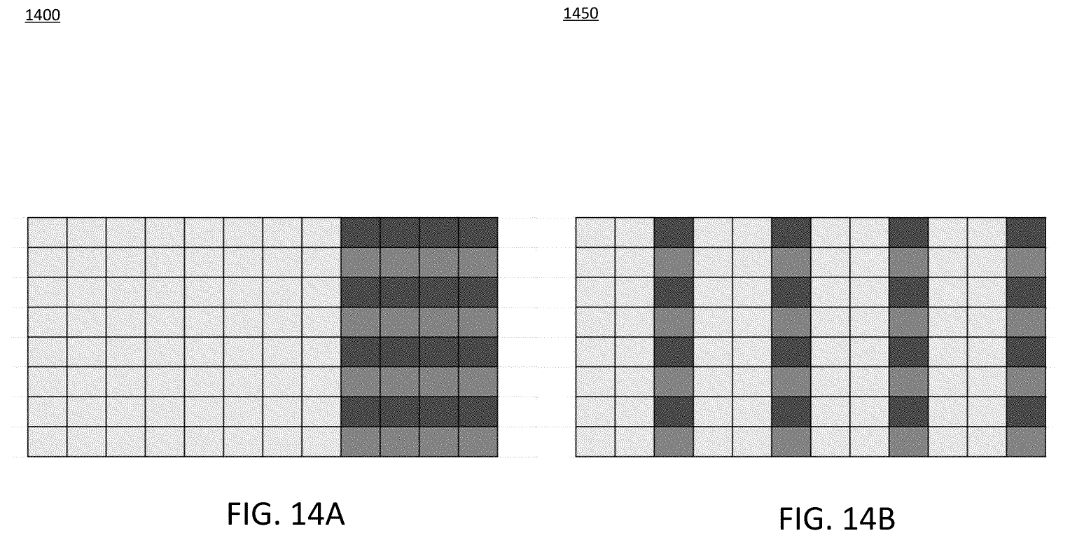

That is, once the dominant and non-dominant colors are re-binned in this manner, the values of each pixel in the reduced size HDR image (i.e. Ysum, Rb, Bw) may be encoded in any suitable manner prior to being companded and transmitted to the AV/ADAS system 1050. For example, the pixel values may be concatenated to generate the resized short exposure image that is output by the image resizing block 1010, as shown in FIG. 10. This may include, for instance, transmitting the dominant and non-dominant resized encoded pixel values either as a separate grouping, as shown in FIG. 14A or, alternatively, in a column-interleaved fashion, as shown in FIG. 14B.

Regardless of the manner in which the pixel values are encoded, embodiments include the AV/ADAS system 1050 receiving the resized short exposure image data having knowledge of the re-binning scheme used to do so. Thus, the AV/ADAS system 1050 may decompress the short exposure HDR image in this manner in accordance with Equations 1-3 and information regarding the weights a, c, c, d, used to generate the encoded pixel values. Thus, as is the case when resizing is not implemented, the AV/ADAS system 1050 may linearize the companded (e.g. 12b pixel values) to a larger 24b value. However, it is noted that this is optional regardless of whether the resizing operations are implemented, as the AV/ADAS system 1050 may alternatively decode the PWL companded HDR data transmitted by the PWL companding block 1008 to obtain any suitable image data sets (e.g. tone mapped, color ratio, etc.) from the compressed (e.g. companded) HDR images.

Viii. Performance Analysis of HDR Imager

An illustrative example demonstrating the impact on bandwidth and memory allocation for the conventional (single image) use case and the embodiments as discussed herein, which implement a size reduction for the second Exp 2 HDR image as well as a reduced 10 bpp for each image, is shown in Tables 1 and 2 below. For instance, the sum of storage required for both images is 114.05 Mb compared to 99.53 Mb for transmitting a single image as part of a conventional serial transmission, an increase of less than 15%. Moreover, the sum of bandwidth required for the transmission of both images requires 3.61 Gbps compared to 2.99 Gbps for transmitting a single image as part of a conventional serial transmission, an increase of less than 20%.

TABLE 1

| Data Storage | w | h | bpp | Storage (Mb) |
|---|---|---|---|---|
| Single image | 3840 | 2160 | 12 | 99.53 |
| Image Exp 1 | 3840 | 2160 | 10 | 82.94 |
| Image Exp 2 | 2880 | 1080 | 10 | 31.10 |

TABLE 2

| Data Rate | Tframe (ms) | Trow (μs) | BW (Gbps) |
|---|---|---|---|
| Single Image: 8M 30fps 12 b | 33.3 | 15.4 | 2.99 |
| Image Exp 1: 8M 30fps 10 b | 33.3 | 15.4 | 2.49 |
| Image Exp 2: 2M 30fps 10 b | 33.3 | 30.9 | 1.12 |

Additionally, the use of a high gain pixel read may enable the additional of quantization noise when the bpp of the output HDR images is reduced. That is, and as noted above, embodiments include the sensor control unit 1004 configuring the HDR imager 1000 such that the multi-pixel reads for both the longer exposure image Exp 1 and the short exposure image Exp 2 begins with a dual-conversion gain capture from each pixel. For example, the dual-conversion gain capture may comprise reading the charge in a location of the pixel at both a high and a low gain. The high gain capture will thus be large enough (e.g. >12×) such that the noise floor of the per column ADCs are not quantized and will be present in the digital signal path. In other words, the higher gain pixel read may result in a noisier ADC output, which allows for the introduction of additional quantization without impacting the digital pixel noise output via the per-column ADCs.

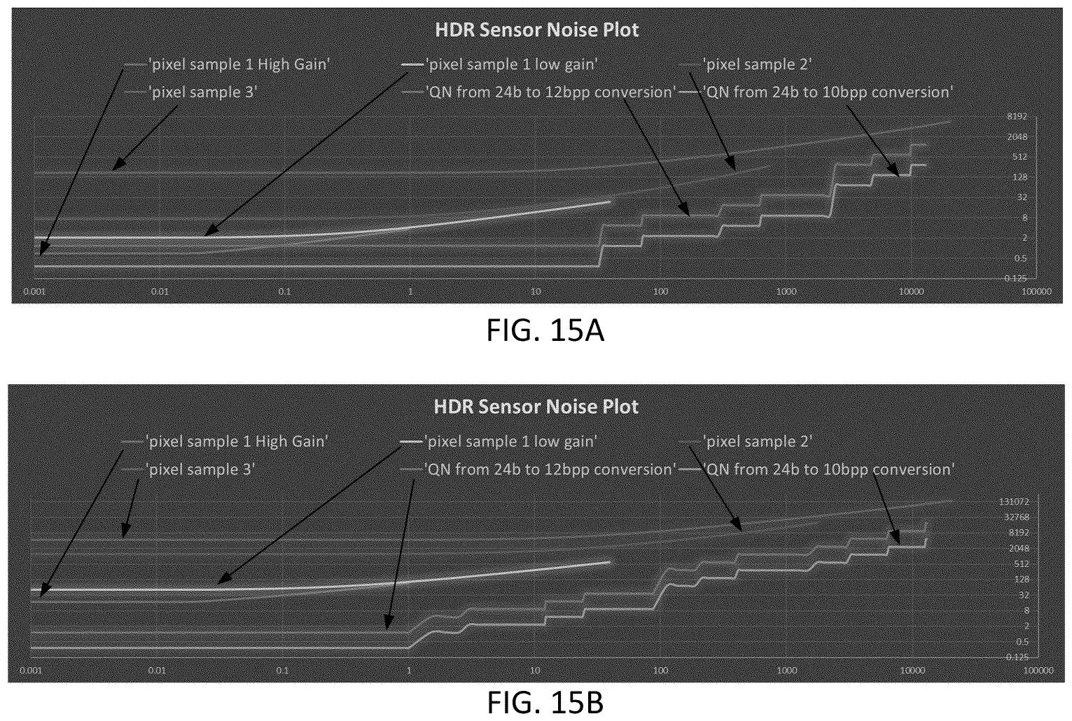

For instance, FIGS. 15A-15B illustrates charts having a vertical axis that represents the digital pixel values prior to PWL companding, and a horizontal axis that represents the light level relative to the digital pixel values. Each line represents the digital noise post-HDR combination for each pixel read. The “QN” (quantization noise) is thus added as a result of the PWL companding, which demonstrates that the QN due to PWL companding is less than the pixel noise at the digital level. This, FIG. 15A shows the intersection of QN from pixel companding with digital pixel noise from HDR combination. In this scenario, the first pixel sample gain is low, which demonstrates that the 24b to 10 bpp conversion has a higher QN compared to the pixel noise at low signal. FIG. 15B shows that if the HDR imager 1000 is configured to use a high gain in the first pixel sample, then the resulting pixel noise floor represented post-HDR will be higher than the QN added by 24b to 10 bpp conversion. As a result, the higher first pixel sample gain enables the lower data size and data rate.

Ix. Applications Utilizing the Generated HDR Images

Given the transmission of the two different exposure images as discussed above, embodiments include improving the total detection possible by a CV system. Again, conventional HDR images provide separate HDR images but require a significant time to do so. The embodiments described herein enable the generation of both long and short exposure HDR images captured at the same time, excepting only for the offset in time between the two images of the shorter exposure image value, as noted above. An example illustrating the result of such a system is shown in FIGS. 16A-16B. First, FIG. 1667A illustrates an example of a longer exposure HDR image, whereas FIG. 16B illustrates an example of a shorter exposure HDR image. From a comparison of these images, it may be observed that the location of the tires with respect to the lane-reflector shows only a negligible difference in location between the two images.

It is also noted that a CV system may thus utilize the longer exposure HDR image to ensure that dark objects are sufficiently illuminated by increasing the sensor integration time for low light scenarios, for instance. However, this increase is limited, as too long of an exposure may cause blurring of objects, such as other passing vehicles, which is partially observed in FIG. 16A. Thus, for conventional CV systems, the general limit for the longer integration time HDR image is about 15 ms. Additionally, for conventional ADAS/AV image sensors, the frame-rate of the imager is 30 fps, such that the maximum integration time that may be achieved without reducing the sensor frame-rate is 33 ms (=1/30 fps). However, by adding a second HDR image that is exposed at a shorter duration (e.g. 1 ms), which is transmitted close in time with the longer exposure image, the ADAS/AV system may increase the integration time for the longer exposure HDR image without the concern of blurring objects. This is because objects that would experience blur may now be detected using the second, short exposure HDR image.

Thus, embodiments include selectively adjusting the exposure time of the longer exposure HDR image and/or the exposure time of the shorter exposure HDR image based upon a predetermined condition being satisfied. As an illustrative example, the HDR imager 1000 may increase (e.g. via the sensor control unit 1004 as instructed via the AV/ADAS system 1050) further increasing the exposure time of the longer exposure HDR image from 15 ms to 30 ms. In this example, the low light detection of the ADAS/AV system 1050 increases by a factor of two. Thus, and continuing this illustrative example, the vehicle 100 may implement the HDR imager 1000 during the day using a longer exposure HDR image with an exposure time of 15 ms, and then adjust the exposure time from 15 ms to 30 ms at night. The selective adjustment of the exposure time of the longer exposure HDR image may be performed in this manner in accordance with any suitable predetermined conditions being met, such as for instance based upon the time of day, whether it is day or night, the speed of the vehicle, a location of the vehicle, etc.

An example of the use of a longer exposure time in this manner is shown in further detail with respect to FIGS. 17A-16B. FIGS. 17A-17B thus illustrate an example of improved low-light detection gained from doubling the long exposure integration time from 15 ms to 30 ms. In this example, FIG. 17A illustrates that the lane marks on a road in the distance were nearly invisible for a 15 ms exposure time HDR image, but become visible in the longer 30 ms exposure time HDR image shown in FIG. 17B.

Additionally or alternatively, the AV/ADAS system 1050 may selectively adjust the shorter exposure HDR image, which may include further shortening the exposure time based upon one or more predetermined conditions being satisfied. Such conditions may include any suitable conditions that may be detected by the AV/ADAS system 1050 based upon any suitable sensor data that is acquired via the vehicle 100. As an illustrative example, a bright light source may oversaturate and “blind” the first, longer exposure HDR image, and the AV/ADAS system 1050 may have difficulties identifying this condition. Thus, embodiments include the AV/ADAS system 1050 detecting this blinding condition of the HDR imager 1000 by determining whether the same location of pixels (or a subset thereof) in the shorter exposure HDR image (or a further shortened exposure time HDR image) also include these saturated pixel values. Thus, such a condition may be detected in this manner when this is the case, as the saturated pixel values are not solely due to the longer integration time, but instead are a result of a particular light source given the effect being present in both images.

Additionally or alternatively, the AV/ADAS system 1050 may utilize the two HDR images as discussed above, which again may be generated nearly concurrently excepting for the time offset of the shorter exposure HDR image, to perform any suitable type of vehicle-based functions. Such functions may include, for example, feature and/or object classification with respect to a driving environment used by vehicle 100. For example, the AV/ADAS system 1050 may implement one or more CV algorithms as noted above as part of the execution of such vehicle-based functions. In various embodiments, the object classification may comprise the classification of any suitable type of object that may be present, for instance, within a scene. The AV/ADAS system 1050 may do so using the two HDR (e.g. long and short exposure time) HDR images as discussed herein.

As one example, the AV/ADAS system 1050 may use the generated HDR images to classify a light source captured within a scene based upon a comparison of the long and the short exposure HDR images. Such a classification may include, for example, the classification of distant light sources (e.g. tail-lights), which may otherwise be difficult for conventional systems to detect, as the light emitted from these light sources is diminished over distance (e.g. 50m). Moreover, if such a detection process occurs on a bumpy road, the small movements of the long exposure HDR image may lead to such lights appearing blurry. In this case, if the AV/ADAS system 1050 were to only utilize the long exposure HDR image to detect the presence of a light source, it may be unable to detect the shape of the light source and classify it correctly. Alternatively, if the AV/ADAS system 1050 were to only utilize the short exposure HDR image for the detection of such a light source, the object may be considered a noisy shaped light source because the low SNR of the light provides a low probability of such a light source existing.

However, in accordance with the embodiments as described herein, such a light source may be classified based upon a comparison of the first and the second HDR images. For example, the CV system implemented by the AV/ADAS system 1050 may use the longer exposure HDR image to assess a higher probability of a light source existing without an ability to classify it. And, because the images are captured at essentially the same time, the noisy shape in the short exposure may be assigned a higher probability of being a light source. Therefore, the ability of the CV system to detect such distant and dim light sources advantageously increases.

### X. An Overall Process Flow

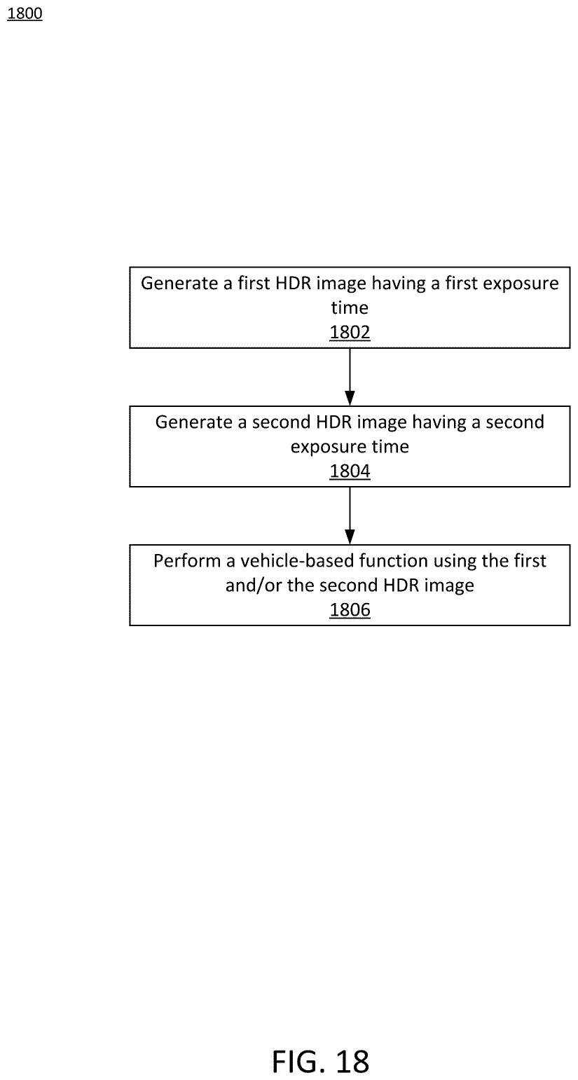

FIG. 18 illustrates an example overall process flow, in accordance with one or more aspects of the present disclosure. With reference to FIG. 18, the flow 1800 may be a computer-implemented method executed by and/or otherwise associated with one or more processors (processing circuitry) and/or storage devices. These processors and/or storage devices may be associated with one or more computing components identified with the safety system 200 of the vehicle 100 as discussed herein (such as the one or more processors 102, one or more of the processors 214A, 214B, 216, 218, etc.), the AV/ADAS system 1050, etc. Alternatively, the processors and/or storage devices may be identified with a separate computing device that may be in communication with the vehicle 100, such as an aftermarket computing device. As yet another example, the processors and/or storage devices may be identified with the image sensor(s) themselves, e.g. as part of a chip, an SoC, or ASIC that may optionally include the image sensor, such as the HDR imager 1000 for instance as discussed herein. In the optional scenario in which the image sensor is part of such a chip, SoC, ASIC, etc., any portion of the process flow 1800 may be performed via the image sensor as opposed to or in addition to the vehicle controllers/processors.

In any event, the one or more processors identified with one or more of the components as discussed herein may execute instructions stored on other computer-readable storage mediums not shown in the Figures (which may be locally-stored instructions and/or as part of the processing circuitries themselves). The flow 1800 may include alternate or additional steps that are not shown in FIG. 18 for purposes of brevity, and may be performed in a different order than the steps shown in FIG. 18. For instance, although the process flow 1800 illustrates blocks that proceed in a linear and sequential manner, any portions of the process flow 1800 may be performed concurrently (e.g. in parallel) with one another or, alternatively, in a sequential manner. For instance, the first and second HDR images may be generated in parallel and within the same frame time, as noted herein.

Flow 1800 may include one or more processors generating (block 1802) a first HDR image having a first exposure time. The first HDR image may include, for example, the first, longer exposure time image Exp 1 as shown and discussed herein with respect to FIG. 10.

Flow 1800 may include one or more processors generating (block 1804) a second HDR image having a second exposure time. The second HDR image may include, for example, the second, shorter exposure time image Exp 2 as shown and discussed herein with respect to FIG. 10.

Flow 1800 may include one or more processors performing (block 1806) a vehicle-based function using the first and/or the second HDR images. This vehicle-based function may include, for example, a feature and/or object classification, a navigation-based function, a control-based function, issuing an alert, or any of the other vehicle-based functions as discussed herein.

### XI. A Computing Device

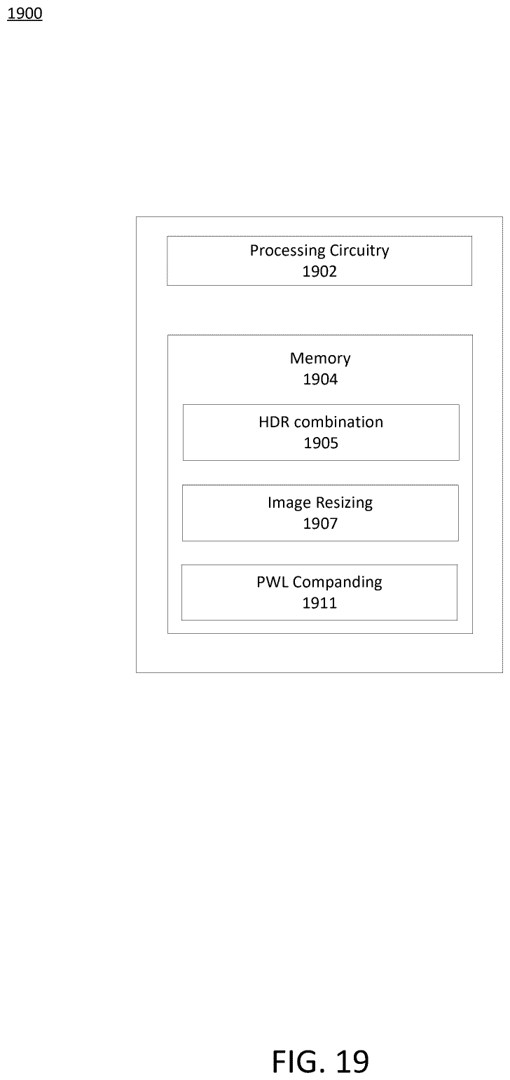

FIG. 19 illustrates a block diagram of an exemplary computing device, in accordance with an aspects of the disclosure. In an aspect, the computing device 1900 as shown and described with respect to FIG. 19 may be identified with a component of the safety system 200 as discussed herein, as a separate computing device that may be implemented within the vehicle 100 or in any suitable environment, and/or as a chip or other suitable type of integrated circuit, system on a chip (SoC), ASIC, etc. As another example, the computing device 1900 as shown and described with respect to FIG. 19 may be identified with the sensor control unit 1004. As further discussed below, the computing device 1900 may perform the various functionality as described herein with respect to generating and/or transmitting HDR images to any suitable components of the vehicle 100, such as the AV/ADAS system 1050 for instance.

To do so, the computing device 1900 may include processing circuitry 1902 and a memory 1904. The components shown in FIG. 19 are provided for ease of explanation, and the computing device 1900 may implement additional, less, or alternative components as those shown in FIG. 19.

The processing circuitry 1902 may be configured as any suitable number and/or type of computer processors, which may function to control the computing device 1900 and/or other components of the computing device 1900. Alternatively, if the computing device 1900 is identified with a component implemented via the HDR imager 1000, the processing circuitry 1902 may function to perform the same functionality as discussed herein with reference to the sensor control unit 1004, the HDR combination block 1006, the image resizing block 1010, and the PWL companding block 1008, such that the HDR imager 1000 may output the HDR images as discussed herein. The processing circuitry 1902 may be identified with one or more processors such as a host processor, a digital signal processor, one or more microprocessors, graphics processors, baseband processors, microcontrollers, an application-specific integrated circuit (ASIC), part (or the entirety of) a field-programmable gate array (FPGA), etc.

In any event, the processing circuitry 1902 may be configured to carry out instructions to perform arithmetical, logical, and/or input/output (I/O) operations, and/or to control the operation of one or more components of computing device 1900, the vehicle 100, and/or the HDR imager 1000 to perform various functions as described herein. The processing circuitry 1902 may include one or more microprocessor cores, memory registers, buffers, clocks, etc., and may generate electronic control signals associated with the components of the computing device 1900 to control and/or modify the operation of these components. The processing circuitry 1902 may communicate with and/or control functions associated with the memory 1904.

The memory 804 is configured to store data and/or instructions such that, when the instructions are executed by the processing circuitry 1902, cause the computing device 1900 to perform various functions as described herein. The memory 1904 may be implemented as any suitable volatile and/or non-volatile memory, including, for example, read-only memory (ROM), random access memory (RAM), flash memory, a magnetic storage media, an optical disc, erasable programmable read only memory (EPROM), programmable read only memory (PROM), etc. The memory 1904 may be non-removable, removable, or a combination of both. The memory 1904 may be implemented as a non-transitory computer readable medium storing one or more executable instructions such as, for example, logic, algorithms, code, etc.

As further discussed below, the instructions, logic, code, etc., stored in the memory 1904 are represented by the various modules as shown in FIG. 19, which may enable the various functions of the aspects as described herein to be functionally realized. Alternatively, if implemented via hardware, the modules shown in FIG. 19 associated with the memory 1904 may include instructions and/or code to facilitate control and/or monitor the operation of such hardware components. In other words, the modules as shown in FIG. 19 are provided for ease of explanation regarding the functional association between hardware and software components. Thus, the processing circuitry 1902 may execute the instructions stored in these respective modules in conjunction with one or more hardware components to perform the various functions as discussed herein.

The executable instructions stored in the HDR combination module 1905 may facilitate, in conjunction with execution via the processing circuitry 1902, the computing device 1900 executing the functionality as discussed herein with reference to the HDR combination block 1006, e.g. generating HDR pixel data from the read HDR pixel exposure data output via the per-column ADCs of the pixel array, as discussed above with respect to FIG. 10.

The executable instructions stored in the image resizing module 1907 may facilitate, in conjunction with execution via the processing circuitry 1902, the computing device 1900 executing the functionality as discussed herein with reference to the image resizing block 1010, e.g. resizing one or both of the HDR images using various color binning schemes.

The executable instructions stored in the PWL companding module 1911 may facilitate, in conjunction with execution via the processing circuitry 1902, the computing device 1900 executing the functionality as discussed herein with reference to the PWL companding block 1008, e.g. performing PWL companding on the original or resized HDR images.

### XII. Leveraging the Generated HDR Images as Part of an Image Compression Scheme

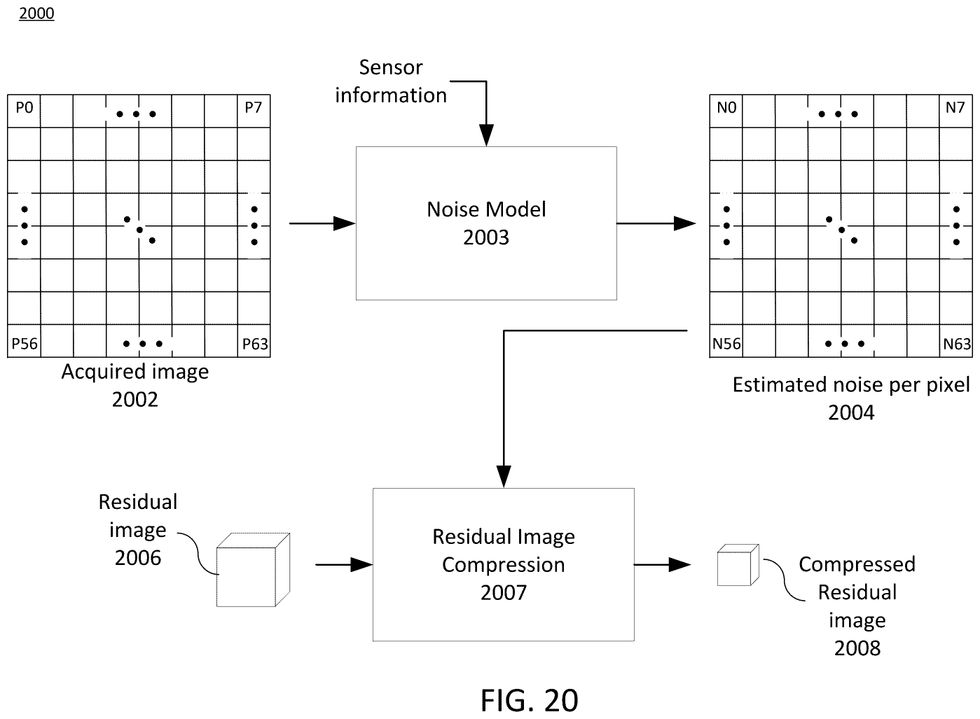

FIG. 20 illustrates an example of noise model based compression for residual image compression, in accordance with one or more aspects of the present disclosure. The noise model based compression is further discussed below, but it is first noted that it may be desirable to used image-based compression techniques to reduce bandwidth and the amount of space needed to store acquired images. To this end, many image/video codecs rely on image prediction mechanisms and residual image compression. As part of such compression techniques, a residual image is typically generated that represents a difference between a “real” (i.e. the original) acquired image and the prediction of that image. Thus, the residual image may represent a compressed version of the acquired image, with the original image being restored by combining the prediction with its corresponding residual. The residual image may be further compressed prior to transmission and/or storage.

For instance, predictors may be implemented (not shown) to generate a predicted image from an acquired image. The use of such predictors is generally known, and may include the use of auto-encoders, trained neural networks, or other suitable architectures that function to generate, from the acquired images, corresponding predicted images. Residual image processing may then be performed to subtract the predicted image from the corresponding acquired image to generate the residual image, which may then be compressed to a compressed residual image for storage and/or transmission within the safety system 200. Such acquired images are represented in FIG. 20 as the acquired images 2002, and may be identified with any of the HDR images as discussed herein, such as the first and/or second HDR images having different integration times that are generated via the progressive scanning process as described above with respect to FIGS. 7-8 for instance.

For the embodiments as described in further detail in this Section, the residual compression scheme referenced with respect to FIG. 20 may be performed by any suitable computing device, which may include the computing device 1900 as shown and described with respect to FIG. 19, one or more components of the safety system 200 as discussed herein (such as the one or more processors 102, one or more of the processors 214A, 214B, 216, 218, etc.), the AV/ADAS system 1050, etc., or as a separate computing device that may be implemented within the vehicle 100 or in any suitable environment, and/or as a chip or other suitable type of integrated circuit, system on a chip (SoC), ASIC, etc. The embodiments as described in further detail in this Section may be implemented in addition to or instead of the resizing of the short exposure image data as discussed herein to further reduce the size needed to store and/or transmit the short exposure HDR image.

The residual image 2006 as shown in FIG. 20 represents the difference between the acquired image 2002 and the predicted image (not shown). Thus, the size of the residual image 2006 is smaller when the predictor performs a better prediction, and thus the residual image 2006 may be compressed more easily with more accurate predictions. For instance, the residual image 2006 may comprise all zeroes when a “perfect” prediction is made by the predictor, as in this case the predicted image is the same as the acquired image 2002. The residual image 2006 also has a lower entropy compared to the acquired image 2002.

As a result, the residual image 206 may be further compressed to form the compressed residual image 2008, as shown in FIG. 20. The compressed residual image 2008 may then be stored in any suitable manner, which may include storage in any suitable component of the vehicle 100, for example, such as the one or more memories 202. Alternatively, the compressed residual image 2008 may be stored in any suitable manner remote from the vehicle 100, such as in the remote computing system 150, for example. The compressed residual image 2008 may then be subsequently accessed, decompressed, and used to restore the acquired image 202 by combining (e.g. summing) the predicted image (not shown) and the residual image 2006.

Thus, the use of residual images 2006 advantageously allows for a compression of the acquired images 2002. Additionally, the embodiments as further discussed herein function to perform an efficient compression of residual images based upon noise model information that is associated with the source of the originally acquired image 2002. To this end, it is noted that conventional residual image compression techniques leverage “near-lossless” compression settings by allowing for some error to exist in the resulting compressed residual image. To ensure that this error is acceptable, such existing techniques include defining (i.e. bounding) a maximal reconstruction error by reducing the resolution in which the residual image 2006 is saved.

In other words, the residual image 2006 is compressed by reducing its resolution, and this compressed residual image 2008 may then be stored in any suitable location. Then, at a subsequent time, the acquired image 2002 may be reconstructed using the stored compressed residual image 208 and the predicted image. This reconstructed image may then be used for any suitable purpose by the vehicle 100 or another suitable computing system, such as to perform any of the vehicle-based functions as discussed herein for example.

A common technique to perform this reduction in resolution is to drop (i.e. zero out) the last N bits of data used to encode each pixel in the residual image, which may include the last N least significant bits (LSBs). For example, the residual image 2006 may comprise any suitable number of pixels, with each pixel representing an encoded value per color channel such as 0-255 for RGB encoding. In this case, the value of each pixel of the residual image 2006 is encoded using M bits, with M=8 in this example per color. By dropping the last N bits of the M bits used for pixel value encoding, this results in bounding the maximal error of the compressed residual image 2008 by 2^{N-1}. As an illustrative example, if the last 2 LSBs of each encoded value of the residual image 2006 are dropped by zeroing these values, the maximal reconstructed error will be no larger than 2.

Thus, the embodiments as described herein may leverage various compression schemes in conjunction with the generation of the HDR images in accordance with a progressive scanning process as described above with respect to FIGS. 7-8 for instance. As one example, this compression scheme may include dropping additional bits of the residual image 2006, which will result in lower entropy values, allowing for a higher compression of the residual image 2006 prior to being stored. It is noted that current residual image compression techniques drop the same number of bits per each pixel across the entirety of the residual image 2006, which results in a uniform reduction in resolution of the residual image pixel values. In other words, conventional techniques for compressing residual images are not adaptive, as these function to remove the same amount of information per each pixel and do not utilize information regarding the sensor used to obtain the acquired images.

In contrast, the embodiments described herein may leverage additional information from the source sensor used to obtain the acquired image 2002 to optimize or at least improve upon the level of compression that may be applied while not increasing the maximal reconstruction error. This is achieved by exploiting noise model information that is correlated to the type of sensor used to capture the acquired image 2002. For instance, and as noted above the image 2002 may be acquired via one of the image acquisition devices 104, which again may comprise a vehicle camera. Each image acquisition device may have corresponding intrinsic properties that are known in advance by the relevant system (e.g. the safety system 200), which may consider various parameters such as the sensor type, the sensor configuration, settings, optical properties (e.g. optical properties of the camera lens), etc.

Thus, the noise model 2003 may be generated utilizing any suitable parameters of the sensor that is used to provide the acquired image 2002, and which are known to impact the noise level of the acquired images. To provide additional examples, such parameters may comprise gain, exposure, sensor temperature, brightness level, as gain, exposure, and sensor temperature, which all affect the noise level of an acquired frame per brightness level. The statistical model may be generated to use any suitable number and/or combination of such parameters to enable an accurate yet statistical prediction of the expected noise level of the acquired image 2002.

With continued reference to FIG. 4, the noise model 2003 is generated for any suitable number of sensors from which the acquired images 2002 are obtained during operation, as further discussed herein. The noise model 2003 may comprise, for instance, a statistical noise model or any other suitable noise model. Additionally or alternatively, the noise model 2003 may comprise a machine learning trained model. Thus, the noise model 2003 may comprise a statistical model, a machine learning trained model, or combinations of these. The noise model 2003 may comprise any suitable number and/or type of model(s) that are generated based upon a training process, for instance, that utilizes sensor information that is associated with the sensor that generated the acquired image 2002.

In various embodiments, the sensor information in this context may include, for example, the above-referenced intrinsic properties of the sensor, which may include any suitable combination of the parameters described above. The sensor information may also include information regarding the configuration of the sensor, which may include for example exposure values or any other suitable information regarding the sensor configuration. In this way, the noise model 2003 may be trained in accordance with any suitable combination of the intrinsic properties and/or sensor configuration data associated with any suitable number of sensors from which the acquired image 2002 is anticipated to be acquired. Then, once deployed, the trained noise model 2003 receives the acquired image 2002 as well as the sensor information associated with the sensor, as shown in FIG. 20, which are used by the noise model 2003 to compute the estimated noise per pixel 2004 as shown.

The noise model 2003 may thus represent any suitable type of trained model and be implemented, for instance, via a suitable computing device and/or processing circuitry identified with the vehicle 100 and/or the safety system 200. The noise model 2002 may be generated in any suitable manner using the intrinsic properties of a particular sensor, which may comprise the use of a neural network, machine learning, deep learning, etc. Thus, the noise model 2003 is configured to estimate any suitable type of noise associated with the sensor from which the acquired image 2002 was received based upon the manner in which the noise model 2003 was trained. This may include, for instance, the estimation of quantization noise, shot noise, thermal noise, etc., such that the noise model 2003 predicts a specific noise value N0 . . . N63 per pixel in the acquired image 2002, as shown in FIG. 20.

In this way, the noise model 2003 is configured to estimate the noise level in each pixel of the acquired image 2002. Embodiments include the use of a residual image compression block 2007, which may be implemented, for instance, via a suitable computing device and/or processing circuitry, which may for example be identified with the vehicle 100, the safety system 200, and/or other suitable computing device. The residual image compression block 2007 receives the residual image 2006 and the estimated noise per pixel information 2004 as shown in FIG. 20. The residual image compression block 2007 leverages the estimated noise per pixel information 2004 to limit the number of bits dropped per pixel to be equal to the noise per pixel. As a result, when the residual image 2006 is used to generate a reconstructed image of the acquired image 2002, this reconstructed image is just as noisy as the original acquired image 2002 when considering the noise introduced into the acquired image via the corresponding sensor. Thus, when compressed in this manner, the compressed residual image 2008 includes a level of noise that is equal to that of the originally acquired image 2002. And when reconstruction is subsequently applied to obtain the acquired image 2002, the process is more efficient compared to conventional residual compression techniques because the noise present in the originally acquired image 2002 is not reconstructed as part of this process.

Thus, FIG. 20 illustrates the process of estimating the noise per pixel in the acquired image 2002 as part of the compression of the residual image 2006. To do so, during compression the originally acquired image 2002 is provided as an input to the noise model 2003. As a result, an estimation of noise (i.e. an encoded value) per pixel in the acquired image 2002 is output by the noise model 200, which is represented in FIG. 20 as the estimated noise per pixel information 2004. For the example shown in FIG. 20, an acquired image 2002 is shown having a total of 64 pixels for ease of explanation. However, the embodiments described herein may of course be expanded to acquired images having any suitable number of pixels depending upon the particular application.

Thus, the estimated noise values N0-N63 associated with the estimated noise per pixel information 2004 as shown in FIG. 20 represent a per-pixel estimated noise value output by the noise model 2003. These per-pixel noise estimations represent a noise value that is within the same range of the values used to encode the pixel values P0-P63 of the acquired image 2002. In other words, the pixel values P0-P63 may represent an encoded value that represents a linear combination of a signal value and a noise value, and the noise model 2003 is configured to estimate the noise contribution to each of the encoded pixel values P0-P63.

The residual image compression block 2007 uses the per-pixel estimated noise values N0-N63 to compute a minimum number of bits required to encode them. For example, a value of 2 bits would be required to encode a noise value of 4, a value of 3 bits would be required to encode a noise value of 7, etc. This process may be repeated by the residual image compression block 2006 to compute, for each pixel of the acquired image 2002, a corresponding bit value required to encode each estimated noise level. Then, the residual image compression block 2007 may generate the compressed residual image 2008 by dropping a number of bits per pixel (e.g. a number of least significant bits (LSBs)) from each pixel of the residual image 2006 that is equal to each respective bit value required to encode each estimated noise level per pixel.

To provide an illustrative example, noise values of 4 and 7 for N0 and N7, respectively, would result in the residual image compression block 2007 dropping 2 LSBs for the pixel associated with the noise value N0 and dropping 3 LSBs for the pixel associated with the noise value N7. Thus, to perform the residual image compression, for each pixel in the residual image 2006, as many bits are dropped (i.e. zeroed) as the noise model 2003 allows. In this way, the compressed residual image 2008 may be generated by dropping LSBs from the residual image 2006 that are used to encode each pixel. This is done on a pixel-by-pixel basis in accordance with the corresponding bit value per pixel that is required to encode the estimated noise level in the acquired image 2002, thereby achieving a non-uniform reduction in resolution across the pixels of the residual image 2006.

Again, the acquired image 2002 may be subsequently restored from the compressed residual image 2008. When this is done, the reconstructed image will advantageously be perceptually lossless because the noise induced by the compression process as discussed herein will be no higher than the noise induced by the sensor itself. In other words, the reconstructed image will be just “as likely” as the originally acquired image 2002.

It is noted that the above examples describe dropping a number of LSBs for each pixel based upon that pixel's corresponding noise value that is obtained via the noise model 2003. For each of these illustrative examples, the number of pixels dropped is equal to the bit value (i.e. the number of bits) required to encode each estimated noise level per pixel. However, the number of bits dropped in this manner may be less than the number of bits required to encode the noise of each pixel. Thus, the number of bits required to encode each estimated noise level per pixel may represent a maximum number of bits to be dropped that are “allowed” by the noise model 2003, although a lesser number of bits may be dropped in other embodiments.

Such embodiments may be particularly useful, for instance, when the predictions provided by the noise model 2003 are anticipated to be less accurate based upon various factors, a lack of information or parameters from the intrinsic properties of the sensor, etc. In such a case, a larger “safety margin” may be implemented by removing a number of bits that is less than the maximum allowed by the noise model prediction. For instance, a “buffer” of one bit may be implemented such that, using the above example, the residual image compression block 406 would drop 1 LSB (i.e. 1 less than the maximum of 2 LSBs) for the pixel associated with the noise value N0 and drop 2 LSBs (i.e. 1 less than the maximum of 3 LSBs) for the pixel associated with the noise value N7. Any suitable buffer bit value may be used in such scenarios by accepting a tradeoff between compressibility of the residual image 2006 and the ability to accurately restore the initially acquired image 2002.

The use of the noise model 2003 to perform residual image compression may be used in accordance with any suitable type of acquired images 2002. However, the compression scheme as discussed herein with respect to FIG. 20 may be particularly useful in the context of acquiring the first and second HDR images in accordance with the progressive scanning process as described above with respect to FIGS. 7-8. Thus, the compression scheme as discussed herein with respect to FIG. 20 may be modified for this purpose, as further discussed below.

For instance, instead of the conventional use of a predictor to provide the residual image 2006 as discussed above, the residual image 2006 may alternatively be generated as an image that represents the difference between the first and second HDR images having the long and short integration times, as discussed above. For purposes of clarity, the long exposure HDR image may be represented as I₁, whereas the short exposure HDR image may be represented as 12. Thus, the residual image 2006 may be represented as R=I₂−I₁. The long exposure HDR image I₂ and the short exposure HDR image In may represent images of the same scene or, alternatively, a warp operation may be implemented to mitigate temporal movement between the two HDR images. Therefore, it is noted that the content of the two HDR images I₁, I₂ are very similar to one another given their close temporal offset, and thus the residual image 2006 is likely to have a much lower entropy than the two images separately.

As a result, the size of the short exposure HDR image In may be further compressed given its similarity to the long exposure HDR image 12. That is, the residual image compression block 2007 functions to compress the residual image 2006, which results in a compression of the differences between the two HDR images I₁, I₂. And because of the similarity between these two images, the short exposure HDR image I₁ (2002) and the residual image R (2006) may be compressed separately instead of the need to compress both the short and the long exposure HDR images I₁, I₂. Then, the long exposure HDR image I₂ may be restored based upon a calculation of I₂=I₁+R, resulting in a much lower bit rate.

Additionally or alternatively, the noise model 2003 may be implemented to take advantage of the use of the residual image compression in conjunction with the short and the long exposure HDR images I₁, I₂. For instance, and as noted above, given the small temporal offset between the HDR images I₁, I₂, each of the images may be considered to represent essentially the same scene, and are generated by the same image sensor but under different configurations, such as the short and long exposure values as noted above for instance, which are denoted in this Section as E₁, E₂.

Therefore, a nonlinear mapping f may be calculated between the HDR images I₁, I₂ such that I₂=f(I₁, E₁, E₂). This function may be modeled directly by the known camera intrinsic values (camera response curve, etc.) or be fitted by machine learning approaches. Thus, assuming that f is accurate enough, the residual image R=I₂−f(I₁, E₁, E₂) should be approximately equal to the sensor noise. The noise model 2003 may thus be derived using this relationship to provide a very accurate noise model 2003, which may be particularly useful for additional or alternative tasks such as image denoising, image compression, image super resolution, etc.

Additionally or alternatively, the HDR images I₁, I₂ may be compressed in any suitable manner to reduce storage space and/or bandwidth required to transmit these images within an applicable system (e.g. the safety system 200). This may include the use of the noise model-based compression as discussed and shown in FIG. 20, or any other suitable techniques. Regardless of how the compression of the HDR images I₁, I₂ is performed, embodiments include using a comparison between the HDR images I₁, I₂ to identify defective pixels. This is possible given the difference between the two exposures of the two HDR images I₁, I₂, as the long exposure HDR image I₂ is more likely to generate defective pixels than the short exposure HDR image I₁.

That is, defective pixels are often the result of impurities, which output more of an “offset” (e.g. noise) as a function of a longer integration time. In other words, the defective pixel relative to its non-defective pixels will be “stronger” in the long exposure HDR image I₂. However, the short exposure HDR image I₁ will show the same defective pixels with a lower “offset” (e.g. noise contribution). Therefore, embodiments include first identifying any defective pixels in the long exposure HDR image I₂, and then excluding these same pixels when performing the compression of the residual image 2006 (which again represent the difference between the short exposure HDR image I₁ and the long exposure HDR image I₂). In this way, the compression of the residual image 2006 may be further improved by not compressing the defective pixel values.

### EXAMPLES

The following examples pertain to further aspects.

An example (e.g. example 1) relates to a method. The method comprises generating images via an image sensor, comprising: generating a first high dynamic range (HDR) image having a first exposure time; generating a second HDR image having a second exposure time; and performing a vehicle-based function using the first and/or the second HDR image, wherein the second exposure time is shorter than the first exposure time, and wherein the first and the second HDR images are generated having a time offset with respect to one another that is no greater than the second exposure time.

Another example (e.g. example 2) relates to a previously-described example (e.g. example 1), wherein the first and the second HDR images are generated by repeatedly reading (i) first integrated HDR exposure data associated with the first HDR image, and (ii) second integrated HDR exposure data associated with the second HDR image, from different respective rows of a pixel array of an image sensor until the first integrated HDR exposure data and the second integrated HDR exposure data have been read from each row of the pixel array.

Another example (e.g. example 3) relates to a previously-described example (e.g. any combination of examples 1-2), wherein the reading of the first integrated HDR exposure data of a first row in the pixel array is performed concurrently with the reading of the second integrated HDR exposure data associated with a second row in the pixel array.

Another example (e.g. example 4) relates to a previously-described example (e.g. any combination of examples 1-3), the first integrated HDR exposure data is read from a first row in the pixel array, the second integrated HDR exposure data is read from a second row in the pixel array, and the first row and the second row are read from rows positioned within the pixel array based on the second exposure time.

Another example (e.g. example 5) relates to a previously-described example (e.g. any combination of examples 1-4), the first HDR image is generated by iteratively reading, for each row in a pixel array of an image sensor, first HDR exposure data at a first predetermined time after a first HDR integration time reset is performed for each respective row, and the second HDR image is generated by iteratively reading, for each row in the pixel array of the image sensor, second HDR exposure data at a second predetermined time after reading the first HDR exposure data.

Another example (e.g. example 6) relates to a previously-described example (e.g. any combination of examples 1-5), wherein the second predetermined time is based on the second exposure time.

Another example (e.g. example 7) relates to a previously-described example (e.g. any combination of examples 1-6), wherein the first exposure time of the first HDR image is at least 11 milliseconds, and wherein the second exposure time of the second HDR image is no more than 3 milliseconds.

Another example (e.g. example 8) relates to a previously-described example (e.g. any combination of examples 1-7), further comprising: selectively adjusting the first exposure time of the first HDR image and/or the second exposure time of the second HDR image based upon a predetermined condition being satisfied.

Another example (e.g. example 9) relates to a previously-described example (e.g. any combination of examples 1-8), wherein the second HDR image has a lower resolution than the first HDR image.

Another example (e.g. example 10) relates to a previously-described example (e.g. any combination of examples 1-9), wherein generating the second HDR image comprises: generating the second HDR image to have a lower resolution than the first HDR image by performing different color channel binning processes on different respective color channels of the second HDR image.

Another example (e.g. example 11) relates to a previously-described example (e.g. any combination of examples 1-10), wherein generating the second HDR image to have a lower resolution than the first HDR image comprises concatenating encoded pixel values resulting from performing the different color channel binning processes on the different respective color channels.

Another example (e.g. example 12) relates to a previously-described example (e.g. any combination of examples 1-11), wherein the performing the different color channel binning processes on different respective color channels of the initial second HDR image comprises: for a dominant color channel, mapping an average dominant color value of a neighboring set of pixels to a first single pixel; for non-dominant color channels, mapping a weighted sum of color values of a neighboring set of pixels to respective single pixels.

Another example (e.g. example 13) relates to a previously-described example (e.g. any combination of examples 1-12), further comprising: for the non-dominant color channels of the initial second HDR image, selectively adjusting the mapping of the weighted sum of color values of the neighboring set of pixels to respective single pixels based upon a predetermined condition being satisfied.

Another example (e.g. example 14) relates to a previously-described example (e.g. any combination of examples 1-13), wherein the vehicle-based function comprises object classification.

Another example (e.g. example 15) relates to a previously-described example (e.g. any combination of examples 1-14), wherein the object classification comprises classifying a light source based upon a comparison of the first and the second HDR image.

An example (e.g. example 16) relates to a vehicle. The vehicle comprises an image sensor configured to: generate a first high dynamic range (HDR) image having a first exposure time; generate a second HDR image having a second exposure time; and a controller configured to perform a vehicle-based function using the first and/or the second HDR image, wherein the second exposure time is shorter than the first exposure time, and wherein the first and the second HDR images are generated having a time offset with respect to one another that is no greater than the second exposure time.

Another example (e.g. example 17) relates to a previously-described example (e.g. example 16), wherein the image sensor is configured to generate the first and the second HDR images by repeatedly reading (i) first integrated HDR exposure data associated with the first HDR image, and (ii) second integrated HDR exposure data associated with the second HDR image, from different respective rows of a pixel array of the image sensor until the first integrated HDR exposure data and the second integrated HDR exposure data have been read from each row of the pixel array.

Another example (e.g. example 18) relates to a previously-described example (e.g. any combination of examples 16-17), wherein the image sensor is configured to read the first integrated HDR exposure data of a first row in the pixel array concurrently with the reading of the second integrated HDR exposure data associated with a second row in the pixel array.

Another example (e.g. example 19) relates to a previously-described example (e.g. any combination of examples 16-18), wherein: the first integrated HDR exposure data is read from a first row in the pixel array, the second integrated HDR exposure data is read from a second row in the pixel array, and the first row and the second row are read from rows positioned within the pixel array based on the second exposure time.

Another example (e.g. example 20) relates to a previously-described example (e.g. any combination of examples 16-19), wherein the image sensor is configured to: generate the first HDR image by iteratively reading, for each row in a pixel array of the image sensor, first HDR exposure data at a first predetermined time after a first HDR integration time reset is performed for each respective row, and generate the second HDR image by iteratively reading, for each row in the pixel array of the image sensor, second HDR exposure data at a second predetermined time after reading the first HDR exposure data, wherein the second predetermined time is based on the second exposure time.

Another example (e.g. example 21) relates to a previously-described example (e.g. any combination of examples 16-20), wherein the controller is configured to selectively adjust the first exposure time of the first HDR image and/or the second exposure time of the second HDR image based upon a predetermined condition being satisfied.

Another example (e.g. example 22) relates to a previously-described example (e.g. any combination of examples 16-21), the image sensor is configured to generate the second HDR image to have a lower resolution than the first HDR image by performing different color channel binning processes on different respective color channels of the second HDR image, and by concatenating encoded pixel values resulting from performing the different color channel binning processes on the different respective color channels.

Another example (e.g. example 23) relates to a previously-described example (e.g. any combination of examples 16-22), wherein the image sensor is configured to perform the different color channel binning processes on different respective color channels of the initial second HDR image by: for a dominant color channel, mapping an average dominant color value of a neighboring set of pixels to a first single pixel; and for non-dominant color channels, mapping a weighted sum of color values of a neighboring set of pixels to respective single pixels.

Another example (e.g. example 24) relates to a previously-described example (e.g. any combination of examples 16-23), wherein the image sensor is configured to perform the different color channel binning processes on different respective color channels of the initial second HDR image by: for the non-dominant color channels of the initial second HDR image, selectively adjusting the mapping of the weighted sum of color values of the neighboring set of pixels to respective single pixels based upon a predetermined condition being satisfied.

Another example (e.g. example 25) relates to a previously-described example (e.g. any combination of examples 16-24), wherein the vehicle-based function comprises classifying a light source based upon a comparison of the first and the second HDR image.

An example (e.g. example 26) relates to a high dynamic range (HDR) imager. The HDR imager comprises: an HDR image sensor; and a controller configured to control a configuration of the HDR image sensor to cause the HDR imager to: generate a first HDR image having a first exposure time; and generate a second HDR image having a second exposure time, wherein the second exposure time is shorter than the first exposure time, wherein the first and the second HDR images are generated having a time offset with respect to one another that is no greater than the second exposure time.

Another example (e.g. example 27) relates to a previously-described example (e.g. example 26), wherein the controller is configured to control the configuration of the HDR image sensor to generate the first and the second HDR images by repeatedly reading (i) first integrated HDR exposure data associated with the first HDR image, and (ii) second integrated HDR exposure data associated with the second HDR image, from different respective rows of a pixel array of the HDR image sensor until the first integrated HDR exposure data and the second integrated HDR exposure data have been read from each row of the pixel array.

Another example (e.g. example 28) relates to a previously-described example (e.g. any combination of examples 26-27), wherein the controller is configured to control the configuration of the HDR image sensor to read the first integrated HDR exposure data of a first row in the pixel array concurrently with the reading of the second integrated HDR exposure data associated with a second row in the pixel array.

Another example (e.g. example 29) relates to a previously-described example (e.g. any combination of examples 26-28), wherein: the first integrated HDR exposure data is read from a first row in the pixel array, the second integrated HDR exposure data is read from a second row in the pixel array, and the first row and the second row are read from rows positioned within the pixel array based on the second exposure time.

Another example (e.g. example 30) relates to a previously-described example (e.g. any combination of examples 26-29), wherein the controller is configured to control the configuration of the HDR image sensor to: generate the first HDR image by iteratively reading, for each row in a pixel array of the HDR image sensor, first HDR exposure data at a first predetermined time after a first HDR integration time reset is performed for each respective row, and generate the second HDR image by iteratively reading, for each row in the pixel array of the HDR image sensor, second HDR exposure data at a second predetermined time after reading the first HDR exposure data, wherein the second predetermined time is based on the second exposure time.

An apparatus as shown and described.

A method as shown and described.

### CONCLUSION

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processing circuitry” or “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to aspects described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary aspects described herein, processing circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

What is claimed is:

1. A method for generating images via an image sensor, the method comprising:
generating a first high dynamic range (HDR) image having a first exposure time;
generating a second HDR image having a second exposure time; and
performing a vehicle-based function using the first and/or the second HDR image,
wherein the second exposure time is shorter than the first exposure time, and
wherein the first and the second HDR images are generated having a time offset with respect to one another that is no greater than the second exposure time.

2. The method of claim 1, wherein the first and the second HDR images are generated by repeatedly reading (i) first integrated HDR exposure data associated with the first HDR image, and (ii) second integrated HDR exposure data associated with the second HDR image, from different respective rows of a pixel array of an image sensor until the first integrated HDR exposure data and the second integrated HDR exposure data have been read from each row of the pixel array.

3. The method of claim 2, wherein the reading of the first integrated HDR exposure data of a first row in the pixel array is performed concurrently with the reading of the second integrated HDR exposure data associated with a second row in the pixel array.

4. The method of claim 2, wherein:
the first integrated HDR exposure data is read from a first row in the pixel array,
the second integrated HDR exposure data is read from a second row in the pixel array, and
the first row and the second row are read from rows positioned within the pixel array based on the second exposure time.

5. The method of claim 1, wherein:
the first HDR image is generated by iteratively reading, for each row in a pixel array of an image sensor, first HDR exposure data at a first predetermined time after a first HDR integration time reset is performed for each respective row, and
the second HDR image is generated by iteratively reading, for each row in the pixel array of the image sensor, second HDR exposure data at a second predetermined time after reading the first HDR exposure data.

6. The method of claim 5, wherein the second predetermined time is based on the second exposure time.

7. The method of claim 1, wherein the first exposure time of the first HDR image is at least 11 milliseconds, and
wherein the second exposure time of the second HDR image is no more than 3 milliseconds.

8. The method of claim 1, further comprising:
selectively adjusting the first exposure time of the first HDR image and/or the second exposure time of the second HDR image based upon a predetermined condition being satisfied.

9. The method of claim 1, wherein the second HDR image has a lower resolution than the first HDR image.

10. The method of claim 9, wherein generating the second HDR image comprises:
generating the second HDR image to have a lower resolution than the first HDR image by performing different color channel binning processes on different respective color channels of the second HDR image.

11. The method of claim 10, wherein generating the second HDR image to have a lower resolution than the first HDR image comprises concatenating encoded pixel values resulting from performing the different color channel binning processes on the different respective color channels.

12. The method of claim 10, wherein the performing the different color channel binning processes on different respective color channels of the initial second HDR image comprises:
for a dominant color channel, mapping an average dominant color value of a neighboring set of pixels to a first single pixel;
for non-dominant color channels, mapping a weighted sum of color values of a neighboring set of pixels to respective single pixels.

13. The method of claim 12, further comprising:
for the non-dominant color channels of the initial second HDR image, selectively adjusting the mapping of the weighted sum of color values of the neighboring set of pixels to respective single pixels based upon a predetermined condition being satisfied.

14. The method of claim 1, wherein the vehicle-based function comprises object classification.

15. The method of claim 14, wherein the object classification comprises classifying a light source based upon a comparison of the first and the second HDR image.

16. A vehicle, comprising:
an image sensor configured to:
generate a first high dynamic range (HDR) image having a first exposure time;
generate a second HDR image having a second exposure time; and
a controller configured to perform a vehicle-based function using the first and/or the second HDR image,
wherein the second exposure time is shorter than the first exposure time, and
wherein the first and the second HDR images are generated having a time offset with respect to one another that is no greater than the second exposure time.

17. The vehicle of claim 16, wherein the image sensor is configured to generate the first and the second HDR images by repeatedly reading (i) first integrated HDR exposure data associated with the first HDR image, and (ii) second integrated HDR exposure data associated with the second HDR image, from different respective rows of a pixel array of the image sensor until the first integrated HDR exposure data and the second integrated HDR exposure data have been read from each row of the pixel array.

18. The vehicle of claim 17, wherein the image sensor is configured to read the first integrated HDR exposure data of a first row in the pixel array concurrently with the reading of the second integrated HDR exposure data associated with a second row in the pixel array.

19. The vehicle of claim 17, wherein:
the first integrated HDR exposure data is read from a first row in the pixel array,
the second integrated HDR exposure data is read from a second row in the pixel array, and
the first row and the second row are read from rows positioned within the pixel array based on the second exposure time.

20. The vehicle of claim 16, wherein the image sensor is configured to:
generate the first HDR image by iteratively reading, for each row in a pixel array of the image sensor, first HDR exposure data at a first predetermined time after a first HDR integration time reset is performed for each respective row, and
generate the second HDR image by iteratively reading, for each row in the pixel array of the image sensor, second HDR exposure data at a second predetermined time after reading the first HDR exposure data,
wherein the second predetermined time is based on the second exposure time.

21. The vehicle of claim 16, wherein the controller is configured to selectively adjust the first exposure time of the first HDR image and/or the second exposure time of the second HDR image based upon a predetermined condition being satisfied.

22. The vehicle of claim 16, the image sensor is configured to generate the second HDR image to have a lower resolution than the first HDR image by performing different color channel binning processes on different respective color channels of the second HDR image, and by concatenating encoded pixel values resulting from performing the different color channel binning processes on the different respective color channels.

23. The vehicle of claim 22, wherein the image sensor is configured to perform the different color channel binning processes on different respective color channels of the initial second HDR image by:
for a dominant color channel, mapping an average dominant color value of a neighboring set of pixels to a first single pixel; and
for non-dominant color channels, mapping a weighted sum of color values of a neighboring set of pixels to respective single pixels.

24. The vehicle of claim 23, wherein the image sensor is configured to perform the different color channel binning processes on different respective color channels of the initial second HDR image by:
for the non-dominant color channels of the initial second HDR image, selectively adjusting the mapping of the weighted sum of color values of the neighboring set of pixels to respective single pixels based upon a predetermined condition being satisfied.

25. The vehicle of claim 16, wherein the vehicle-based function comprises classifying a light source based upon a comparison of the first and the second HDR image.

26. A high dynamic range (HDR) imager, comprising:
an HDR image sensor; and
a controller configured to control a configuration of the HDR image sensor to cause the HDR imager to:
generate a first HDR image having a first exposure time; and
generate a second HDR image having a second exposure time,
wherein the second exposure time is shorter than the first exposure time,
wherein the first and the second HDR images are generated having a time offset with respect to one another that is no greater than the second exposure time.

27. The HDR imager of claim 26, wherein the controller is configured to control the configuration of the HDR image sensor to generate the first and the second HDR images by repeatedly reading (i) first integrated HDR exposure data associated with the first HDR image, and (ii) second integrated HDR exposure data associated with the second HDR image, from different respective rows of a pixel array of the HDR image sensor until the first integrated HDR exposure data and the second integrated HDR exposure data have been read from each row of the pixel array.

28. The HDR imager of claim 27, wherein the controller is configured to control the configuration of the HDR image sensor to read the first integrated HDR exposure data of a first row in the pixel array concurrently with the reading of the second integrated HDR exposure data associated with a second row in the pixel array.

29. The HDR imager of claim 27, wherein:
the first integrated HDR exposure data is read from a first row in the pixel array,
the second integrated HDR exposure data is read from a second row in the pixel array, and
the first row and the second row are read from rows positioned within the pixel array based on the second exposure time.

30. The HDR imager of claim 26, wherein the controller is configured to control the configuration of the HDR image sensor to:
generate the first HDR image by iteratively reading, for each row in a pixel array of the HDR image sensor, first HDR exposure data at a first predetermined time after a first HDR integration time reset is performed for each respective row, and
generate the second HDR image by iteratively reading, for each row in the pixel array of the HDR image sensor, second HDR exposure data at a second predetermined time after reading the first HDR exposure data,
wherein the second predetermined time is based on the second exposure time.
